(19) United States
(12) Patent Application Publication
(10) Pub. No.: US 2017/0254936 A1
(43) Pub. Date: Sep. 7, 2017

(54) LIGHT REFLECTING FILM, PRODUCTION METHOD FOR LIGHT REFLECTING FILM, DECORATIVE MOLDING METHOD FOR LIGHT REFLECTING FILM, LAMINATED GLASS, AND CURVED SURFACE BODY

(71) Applicant: Konica Minolta, Inc., Chiyoda-ku, Tokyo (JP)

(72) Inventor: TAKAAKI MORITA, Kokubunji-shi, Tokyo (JP)

(21) Appl. No.: 15/320,509

(22) PCT Filed: Aug. 11, 2015
(86) PCT No.: PCT/JP2015/072742

§ 371 Date: Dec. 20, 2016

(30) Foreign Application Priority Data
Aug. 22, 2014 (JP) 2014-168931

(51) Int. Cl. G02B 5/20; G02B 5/26; B32B 37/06; B29C 65/48; B32B 7/02; B32B 7/12

(52) U.S. Cl. CPC G02B 5/208; B32B 7/02; B32B 7/12; B32B 37/06; B29C 65/48; G02B 5/26; B32B 2307/416; B29L 2011/00

(57) ABSTRACT

A light reflecting film may be provided that improves the self-restoring property of a stretched section thereof when stretched and attached to a curved surface and that has excellent scratch resistance and light resistance, a production method for the light reflecting film, a decorative molding method may also be provided for the light reflecting film, laminated glass, and a curved surface body.

### CROSS REFERENCE TO RELATED APPLICATIONS

This is the U.S. national stage of application No. PCT/JP2015/072742, filed on Aug. 11, 2015. Priority under 35 U.S.C. §119(a) and 35 U.S.C. §365(b) is claimed from Japanese Application No. 2014-168931, filed Aug. 22, 2014, the disclosure of which is also incorporated herein by reference.

### TECHNICAL FIELD

The present invention relates to a light reflecting film, a method for producing a light reflecting film, a method for decorative molding of a light reflecting film, laminated glass, and a curved surface body. More specifically, the present invention relates to a light reflecting film which allows an improvement of a deterioration of self-restoring property of a stretched section when the film is stretched and attached to a curved surface and has excellent scratch resistance and light resistance, a method for producing the light reflecting film, a method for decorative molding of the light reflecting film, laminated glass, and a curved surface body.

### BACKGROUND ART

When a light reflecting member is used in an outdoor environment, it is required for a substrate to have scratch resistance and light resistance. Accordingly, a hard coat layer is generally formed on a substrate. However, simple incorporation of a ultraviolet (UV) absorbing agent or a light stabilizer (in the present application, also referred to as HALS) to a common hard coat material is not enough to deal with long-term irradiation with sunlight in an outdoor environment, and a problem occurs in that, as the substrate deteriorates, optical reflectance is lowered.

Meanwhile, there is a demand for using a light reflecting member on a curved surface body like window of an automobile. When a light reflecting member is attached on a curved surface body, the light reflecting member is stretched on the curved part. As such, a problem occurs in that, when attachment is carried out with a common hard coat material, scratches on a hard coat layer are yielded due to residual stress after the attachment.

Patent Literature 1 discloses a technique for having light resistance while keeping a stretching property according to forming, on a decorative film, of a self-restoring surface protective layer which contains an active ray curable polymer containing a hard coating agent, a light stabilizer, and a UV absorbing agent. However, according to the constitution, when a light reflecting member is attached on the aforementioned curved surface body, the light reflecting member is stretched along the curved surface shape. As such, there is a problem that the self-restoring property of a stretched section becomes inferior to the self-restoring property of a non-stretched section and the stretched section has insufficient scratch resistance.

### CITATION LIST

### Patent Literature

Patent Literature 1: JP 2012-206375 A

### SUMMARY OF INVENTION

### Technical Problem

The present invention is devised in consideration of the above problems• circumstances, and the problem to be solved is to provide a light reflecting film which allows an improvement of a deterioration of self-restoring property of a stretched section when the film is stretched and attached to a curved surface and has excellent scratch resistance and light resistance, a method for producing the light reflecting film, a method for decorative molding of the light reflecting film, laminated glass, and a curved surface body.

### Solution to Problem

During the process of determining the cause of the above problems or the like to solve the problem, inventors of the present invention found that, with a light reflecting film having a self-restoring layer formed on a light reflecting body provided with at least a substrate film and a light reflecting layer, in which the restoring degree of the self-restoring layer defined by the following formula has a certain value or more and a buffer layer is formed between the light reflecting body and self-restoring layer, a light reflecting film which allows an improvement of a deterioration of self-restoring property of a stretched section when the film is stretched and attached to a curved surface and has excellent scratch resistance and light resistance can be obtained.

That is, the problem according to the present invention is solved by the following means.

1. A light reflecting film comprising a self-restoring layer which is formed on a light reflecting body provided with at least a substrate film and a light reflecting layer, wherein a restoring degree (A) of the self-restoring layer as defined by the following formula is 0.02 or more, and a buffer layer is provided between the light reflecting body and the self-restoring layer.

A=(h₁−h₂)/hₘₐₓ

h₁: residual depth (μm) measured at an unloading hold time of 0 seconds

h₂: residual depth (μm) measured at an unloading hold time of 60 seconds,

hₘₐₓ: set indentation depth (μm).

2. The light reflecting film according to Item. 1, wherein the buffer layer contains a polymer which is polymerized with a monomer composition containing at least one selected from UV stable monomers and at least one selected from UV absorbing monomers and a ratio of uncured monomer in the buffer layer before decorative molding is 5% by mass or more.

3. The light reflecting film according to Item. 2, wherein the ratio of uncured monomer in the buffer layer after decorative molding is 3% by mass or less.

4. The light reflecting film according to any one of Items. 1 to 3, wherein light reflectance of the light reflecting film in a light wavelength range of 1000 to 1500 nm is 50% or more.

5. The light reflecting film according to any one of Items. 1 to 3, wherein light reflectance of the light reflecting film in a light wavelength range of 450 to 650 nm is 50% or more.

6. A method for producing the light reflecting film according to any one of Items. 1 to 5, comprising:

applying a buffer layer coating solution for forming the buffer layer on the light reflecting body followed by thermal curing; and

then forming a self-restoring layer on the buffer layer without performing an aging treatment.

7. A method for decorative molding of the light reflecting film according to any one of Items. 1 to 5, comprising:

forming a sticky layer or an adhesive layer on a surface of the light reflecting film opposite to the self-restoring layer; and

attaching the light reflecting film to a substrate via the sticky layer or adhesive layer while performing thermal molding at temperature of 80° C. or higher.

8. Laminated glass obtained by sandwiching the light reflecting film according to Item. 4 between two members for constituting laminated glass.

9. A curved surface body comprising the light reflecting film according to Item. 5.

### Advantageous Effects of Invention

According to the above-described means of the present invention, it is possible to provide a light reflecting film which allows an improvement of a deterioration of self-restoring property of a stretched section when the film is stretched and attached to a curved surface and has excellent scratch resistance and light resistance, a method for producing the light reflecting film, a method for decorative molding of the light reflecting film, laminated glass, and a curved surface body.

Although the mechanism for exhibiting the effect or the working mechanism of the present invention remains unclear, it is believed as follows.

A polymer having self-restoring property can restore elastic deformation against external stress and also can self-restore small scratches on a surface. Thus, by forming a self-restoring layer containing this polymer as a surface protecting layer, it is expected to have an excellent effect of impact resistance and scratch resistance. Meanwhile, once the self-restoring layer undergoes plastic deformation, deformations like scratch cannot be restored.

When a light reflecting film is attached to a curved surface body like a window of an automobile, the light reflecting film is stretched in a curved surface part. According to the constitution of Patent Literature 1 described above, the self-restoring layer is stretched with a substrate film so that the attachment to various curved surface shapes can be made. However, according to that constitution, there is a problem of having an easy occurrence of scratches in a stretched section as the scratch resistance (self-restoring property) of a stretched section is inferior to the scratch resistance of a non-stretched section.

In this regard, it is believed that, as a strong deformation stress is applied from a substrate side to a self-restoring layer at the time of attachment to a curved surface shape, part of the self-restoring layer on the substrate side in a stretched section is plasticized so that an elastic deformation region in layer thickness direction is reduced, yielding deteriorated self-restoring performance.

The present invention is characterized in that the elasticity of a self-restoring layer is controlled to a specific range and a buffer layer is formed between a light reflecting body and the self-restoring layer. It was found that, according to such constitution, the deformation stress at substrate side which occurs as a result of stretching for attachment to a curved surface shape is absorbed by the self-restoring layer and buffer layer, and thus the substrate side of the self-restoring layer is not plasticized and the self-restoring performance of a stretched section is not deteriorated.

As a result, it is believed that desired scratch resistance can be achieved even after molding into a curved surface shape.

It was also found that, when a polymer having light stability and light absorbing property for ultraviolet ray is contained in the buffer layer according to the present invention and a ratio of an uncured monomer relative to the entire polymer in the buffer layer before and after decorative molding is adjusted to a specific amount range, the elastic deformation range of the self-restoring layer can be further broadened. In this regard, it is believed that, by having the buffer layer according to the present invention, deformation stress from a substrate during or after molding is absorbed even for a decorative molding involved with stretching of the light reflecting film to a curve surface shape so that an occurrence of deteriorated light resistance caused by ultraviolet ray can be suppressed and excellent scratch resistance and excellent light resistance are obtained while scratch resistance of the self-restoring layer is maintained.

### BRIEF DESCRIPTION OF DRAWINGS

FIG. 1A is a load test force-indentation depth curve at an unloading hold time of 0 seconds for calculating h₁.

FIG. 1B is a load test force-indentation depth curve at an unloading hold time of 60 seconds for calculating h₂.

FIG. 2 is a cross-sectional view illustrating the configuration of the light reflecting film of the present invention.

FIG. 3 is a cross-sectional view illustrating one example of the configuration of the light reflecting film provided with an infrared reflecting layer.

FIG. 4 is a cross-sectional view illustrating another example of the configuration of the light reflecting film provided with an infrared reflecting layer.

FIG. 5A is a cross-sectional view illustrating the configuration of the light reflecting film provided with a film mirror.

FIG. 5B is a cross-sectional view illustrating another configuration of the light reflecting film provided with a film mirror.

### DESCRIPTION OF EMBODIMENTS

This light reflecting film of the present invention is characterized in that it is a light reflecting film in which a self-restoring layer is formed on top of a light reflecting body provided with at least a substrate film and a light reflecting layer, the restoring degree (A) of the self-restoring layer as defined by the formula shown above is 0.02 or more, and a buffer layer is formed between the light reflecting layer and self-restoring layer. Those characteristics are technical characteristics that are common to the inventions of claims 1 to 9.

According to an embodiment of the present invention, from the viewpoint of exhibiting the effect of the present invention, it is preferable that the buffer layer contains a polymer which is polymerized from a monomer composition containing at least one selected from UV stable monomers and at least one selected from UV absorbing monomers and a ratio of an uncured monomer in the buffer layer before decorative molding is 5% by mass or more to suppress plastic deformation of a self-restoring layer as the deformation stress from a substrate at the time of stretching a light reflecting film to a curved surface shape and attaching it for decorative molding is absorbed by the buffer layer.

Furthermore, according to a preferred embodiment, the ratio of an uncured monomer in the buffer layer after decorative molding is 3% by mass or less from the viewpoint of enhancing the scratch resistance of the buffer layer itself, since there may be a case in which, if the buffer layer itself is too flexible, scratches may easily occur in the buffer layer when the deformation stress from an outside is absorbed by the self-restoring layer and buffer layer after the decorative molding.

The light reflecting film having light reflectance of 50% or more in the light wavelength range of 1000 to 1500 nm is appropriate as a heat blocking film to be applied for a window, and it is an embodiment which is preferred for an IR reflecting film.

Furthermore, the light reflecting film having light reflectance of 50% or more in the light wavelength range of 450 to 650 nm is a preferred embodiment since a sunlight reflecting film or a decorative film with metal gloss can be prepared with it.

As for the method for producing a light reflecting film to produce the light reflecting film of the present invention, if a buffer layer coating solution for forming the buffer layer is applied on the light reflecting body followed by thermal curing and then a self-restoring layer is formed on the buffer layer without performing an aging treatment, ratio of an uncured monomer in the buffer layer before decorative molding can be controlled to a certain value or higher and deformation stress from a substrate can be effectively absorbed by the buffer layer even when the light reflecting film is stretched and attached in a curved surface shape. Accordingly, a deterioration in the scratch resistance of the self-restoring layer can be suppressed.

With regard to the decorative molding method of a light reflecting film of the present invention, it is preferable that a sticky layer or an adhesive layer is formed on a surface of the light reflecting film which is opposite to the self-restoring layer and the light reflecting film is attached via the sticky layer or adhesive layer while performing thermal forming on a substrate at temperature of 80° C. or higher. By having such temperature or higher, part of an uncured polymer in the buffer layer can be also thermally cured and its ratio can be controlled to a specific value or lower. Thus, it is preferable in that the buffer layer after deformation into a curved surface shape can undergo deformation as it follows the deformation of the self-restoring layer in accordance with outside stress and an occurrence of scratches or the like in the buffer layer itself is suppressed.

It is preferable that the light reflecting film of the present invention is sandwiched by 2 pieces of a member for constituting laminated glass to give laminated glass.

It is also preferable that the light reflecting film of the present invention is provided on a substrate with curved surface shape to form an article with curve surface shape.

Hereinbelow, the present invention and constitutional elements of the invention, and modes•embodiments for carrying out the present invention are described in detail. Furthermore, the term “to” described in the present application is used to have a meaning which includes the numerical values given before and after it as the lower limit value and upper limit value, respectively.

<<Outline of Light Reflecting Film of the Present Invention>>

The light reflecting film of the present invention is a light reflecting film having a self-restoring layer formed on a light reflecting body provided at least with a substrate film and a light reflecting layer, and it is characterized in that the restoring degree (A) of the self-restoring layer as defined by the following formula is 0.02 or more and a buffer layer is formed between the light reflecting body and the self-restoring layer.

A=(h₁−h₂)/hₘₐₓ

h₁: residual depth (μm) measured at an unloading hold time of 0 seconds
h₂: residual depth (μm) measured at an unloading hold time of 60 seconds,
hₘₐₓ: set indentation depth (μm).

Herein, the restoring degree (A) is a value which is obtained by the above-defined formula according to a load-unload test with set indentation depth, and the test is performed according to the following method, for example.

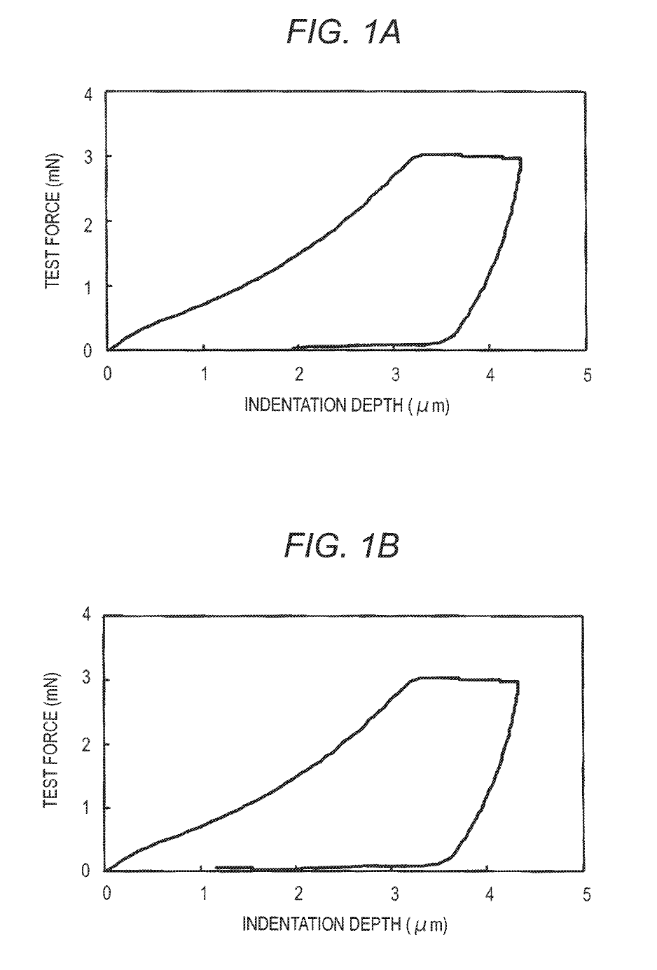

FIG. 1 is a graph illustrating an exemplary load test force-indentation depth curve (i.e., curve obtained by load-unload test with set indentation depth) at the time of pressing an indenter at indentation depth, in which the graph is obtained by measuring the light reflecting film according to this embodiment, and h₁ and h₂ are calculated based on the graph.

FIG. 1A is a load test force-indentation depth curve at an unloading hold time of 0 seconds for calculating h₁.

FIG. 1B is a load test force-indentation depth curve at an unloading hold time of 60 seconds for calculating h₂.

<Load-Unload Test with Set Indentation Depth>

By using a micro hardness tester which uses a Vickers indenter and a pyramid indenter with a ridge line angle of 115 degrees, a surface of the light reflecting film is pressed with an indenter with set indentation depth hₘₐₓ (μm) and the load test force-indentation depth curve is established. In addition, from the residual depth (h₁, h₂) which is obtained by the measurement with unloading hold time of 0 seconds or 60 seconds for the light reflecting film, A=(h₁−h₂)/hₘₐₓ) is calculated. This measurement is performed for 5 different spots of a sample, and the average value is calculated and used as restoring degree (A).

As an example of specific conditions for measurement, the measurement can be made at the following conditions by using Dynamic Ultra-Micro Hardness Tester DUH-211S (manufactured by SHIMADZU CORPORATION).

Indenter shape: Pyramid indenter (ridge line angle of 115°)

Measurement environment: Temperature of 23° C. and relative humidity of 50%
Maximum test load: 196.13 mN
Loading speed: 6.662 mN/10 seconds
Unloading speed: 6.662 mN/10 seconds

Value of the restoring degree (A) obtained according to the above formula represents a self-restoring property, and when it is 0.02 or higher, it can be said to have the self-restoring property mentioned in the present application. That is, it indicates smaller residual depth h₂ compared to the residual depth h₁, and it can be said that, as the difference between them increases, elasticity of the self-restoring layer is higher, representing a higher self-restoring property.

The restoring degree (A) according to the above load-unload test with set indentation depth is preferably in a range of 0.02 to 0.90, and more preferably in a range of 0.20 to 0.70. When it is a range of not greater than 0.90, both the hard coat property and self-restoring property can be obtained.

<Specific Configuration of Light Reflecting Film of the Present Invention>

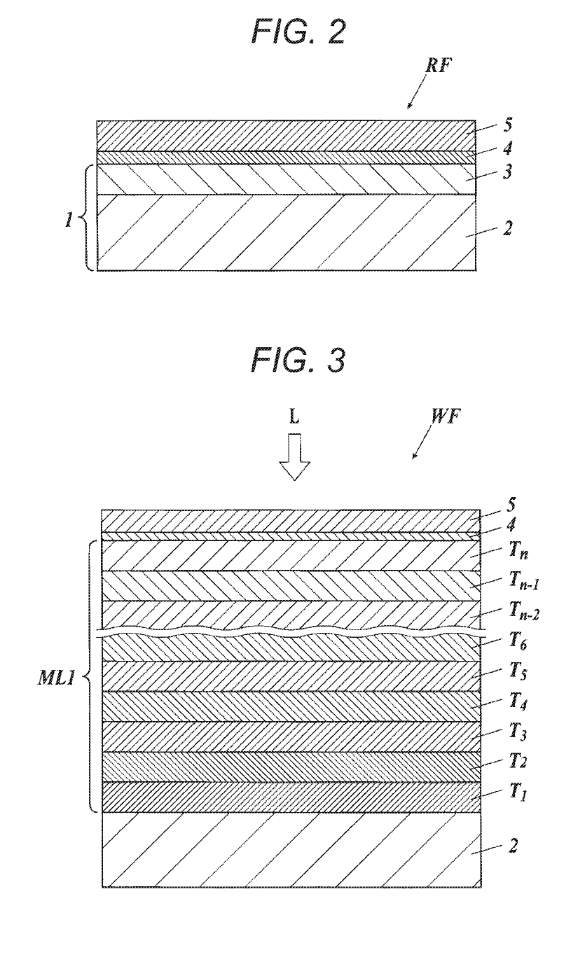

Minimum configuration of the light reflecting film RF of the present invention is shown in FIG. 2.

The light reflecting film RF of the present invention has a configuration in which a self-restoring layer 5 is disposed on any one surface of a light reflecting layer of a light reflecting body 1 having a light reflecting layer 3 on at least one surface of a substrate film 2, and a buffer layer 4 is disposed between the light reflecting body 1 and the self-restoring layer 5.

In a space between layers and on top of the self-restoring layer, a functional layer may be disposed, if necessary, although it is not illustrated. Furthermore, it is preferable that, on a surface of the substrate film 2 which is opposite to the self-restoring layer 5, a sticky layer or an adhesive layer is formed such that the light reflecting film can be attached to the substrate.

Hereinbelow, each constitutional layer is described in detail.

[1] Self-Restoring Layer

The self-restoring layer according to the present invention is characterized in that it has the restoring degree (A) of 0.02 or higher, in which the restoring degree (A) is obtained by the load-unload test with set indentation depth when indentation is applied using the aforementioned micro hardness meter. The restoring degree (A) is preferably in a range of 0.02 to 0.90, and more preferably in a range of 0.20 to 0.70. When it is 0.02 or higher, the self-restoring layer can exhibit the self-restoring property of the present application, and when it is 0.90 or lower, excellent mechanical film strength like hard coat property can be obtained.

The self-restoring layer according to the present invention is preferably a layer containing, as a main component, an active ray curable resin which is cured via a crosslinking reaction caused by irradiation with active ray like UV ray and electron beam (also referred to as active energy ray).

As for the active ray curable resin which may be used for the self-restoring layer of the present invention, a component having a monomer with ethylenically unsaturated double bond is preferably used, and upon irradiation with active ray like UV ray and electron beam, it is cured to form an active ray curable resin layer. In particular, from the viewpoint of exhibiting the self-restoring property, an active energy ray curable resin with epoxy skeleton and an active energy ray curable resin with an alkyl chain skeleton or an alkylene oxide skeleton are preferable.

Examples of the active energy ray curable resin with epoxy skeleton include epoxy (meth)acrylate.

Epoxy (meth)acrylate is obtained by reacting tricarboxylic acid represented by the following (i) or (ii) with (meth)acrylate having monooxirane ring represented by the following (iii) or (iv).

The tricarboxylic acid represented by (i) or tricarboxylic acid represented by (ii) may be used either singly or in combination thereof. The (meth)acrylate having monooxirane ring represented by (iii) or (meth)acrylate having monooxirane ring represented by (iv) may be used either singly or in combination thereof.

(i): Aliphatic tricarboxylic acid represented by the following Formula (a),

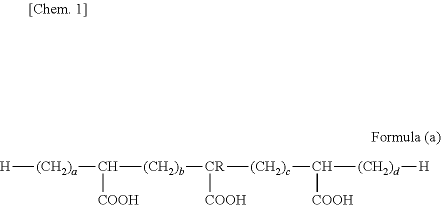

with the proviso that R represents hydrogen or a hydroxyl group. a, b, and d are an integer of from 0 to 8, c is an integer of from 0 to 9, 0≦a+b c d≦9, and [a<d or (a=d and b≦c)].

(ii): Trimellitic acid

(iii): Aliphatic (meth)acrylate having monooxirane ring represented by the following Formula (b),

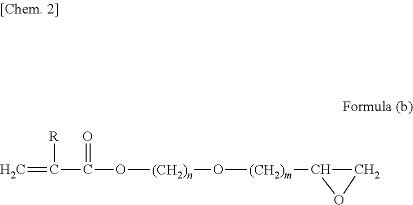

with the proviso that R is hydrogen or a methyl group, n is an integer of from 1 to 5, and m is an integer of from 1 to 3.

(iv): Alicyclic (meth)acrylate represented by the following Formula (c),

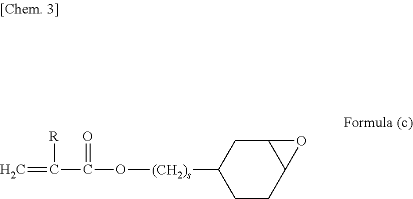

with the proviso that R is hydrogen or a methyl group and s is an integer of from 1 to 10. The epoxy (meth)acrylate has a good balance between a soft segment and a hard segment, and it easily allows obtainment of a property for alleviating external stress.

Examples of the tricarboxylic acid as (i) above include 1,2,4-butane tricarboxylic acid (R is hydrogen, a=0, b=0, c=1, and d=0), 1,3,5-hexane tricarboxylic acid (R is hydrogen, a=0, b=1, c=2, and d=0), 1,2,4-pentane tricarboxylic acid (R is hydrogen, a=0, b=0, c=1, and d=1), 1,2,5-pentane tricarboxylic acid (R is hydrogen, a=0, b=0, c=2, and d=0), 1,3,4-pentane tricarboxylic acid (R is hydrogen, a=0, b=1, c=0, and d=1), 1,2,5-pentane tricarboxylic acid (R is hydrogen, a=0, b=1, c=1, and d=0), 1,2,6-hexane tricarboxylic acid (R is hydrogen, a=0, b=0, c=3, and d=0), 1,2,4-hexane tricarboxylic acid (R is hydrogen, a=0, b=0, c=1, and d=2), 1,4,5-hexane tricarboxylic acid (R is hydrogen, a=0, b=2, c=0, and d=1), 1,3,4-hexane tricarboxylic acid (R is hydrogen, a=0, b=1, c=0, and d=2), 1,3,6-hexane tricarboxylic acid (R is hydrogen, a=0, b=1, c=2, and d=0), 2,3,5-hexane tricarboxylic acid (R is hydrogen, a=1, b=0, c=1, and d=1), 1,4,8-octane tricarboxylic acid (R is hydrogen, a=0, b=2, c=3, and d=0), 1,5,10-nonane tricarboxylic acid (R is hydrogen, a=0, b=3, c=3, and d=0), 1,6,12-dodecane tricarboxylic acid (R is hydrogen, a=0, b=4, c=5, and d=0), and citric acid (R is a hydroxyl group and a=b=c=d=0).

Examples of the trimellitic acid as (ii) above include, in addition to 1,2,4-trimellitic acid, 1,3,5-trimellitic acid and 1,2,3-trimellitic acid.

Examples of the aliphatic (meth)acrylate having monooxirane ring as (iii) above include 4-hydroxybutylacrylate monoglycidyl ether [4-HBAGE, compound of the Formula (b) in which n=4, m=1], 2-hydroxyethylacrylate monoglycidyl ether [2-HEAGE, compound of the Formula (b) in which n=2, m=1].

Examples of the alicyclic (meth)acrylate having monooxirane ring represented by the Formula (c) of (iv) above include acrylate containing alicyclic epoxy group (s=6).

Synthetic Examples are given hereinbelow.

### Synthetic Example 1

To a 4-necked flask equipped with a stirrer, a thermometer, and a condenser, 415.8 parts by mass of toluene, 100 parts by mass of 1,2,4-butane tricarboxylic acid (acid number: 886), 315.8 parts by mass of 4-hydroxybutylacrylate monoglycidyl ether [Nippon Kasei Chemical Co., Ltd., 4-HBAGE], and 0.1 part by mass of hydroquinone monomethyl ether were added and heated to 100° C. After confirming complete dissolution of 1,2,4-tricarboxylic acid, 2 parts by mass of TPP (triphenylphosphine) were added. After maintaining it at the same temperature for 24 hours, the reaction was terminated. As a result, epoxy acrylate having solid content of 50% by mass and acid number of 4.2 mgKOH/g (in terms of solid content) was obtained. Yield was 96.1%.

Examples of the active energy ray curable resin with an alkyl chain skeleton or an alkylene oxide skeleton include urethane (meth)acrylate, which is obtained by reacting (meth)acrylate ((P1) shown below) that is obtained by adding 1 to 20 moles of an alkylene oxide with 2 to 4 carbon atoms to (meth)acrylate having 1 hydroxyl group and 3 or more (meth)acryloyl groups in the molecule and polyisocyanate ((P2) shown below).

Examples of the (meth)acrylate having 1 hydroxyl group and 3 or more (meth)acryloyl groups in the molecule include pentaerythritol tri(meth)acrylate, diglycerin tri(meth)acrylate, dimethylol propane tri(meth)acrylate, xylitol tetra(meth)acrylate, triglycerol tetra(meth)acrylate, dipentaerythritol penta(meth)acrylate, and sorbitol penta(meth)acrylate.

Among them, (meth)acrylate having 1 hydroxyl group and 3 to 5 (meth)acryloyl groups in the molecule is preferable, and examples thereof include pentaerythritol tri(meth)acrylate, xylitol tetra(meth)acrylate, triglycerol tetra(meth)acrylate, and dipentaerythritol penta(meth)acrylate. More preferred examples include pentaerythritol tri(meth)acrylate and dipentaerythritol penta(meth)acrylate.

As for the type of alkylene oxide used for the addition polymerization, alkylene oxide with 2 to 4 carbon atoms can be used. Specific examples thereof include ethylene oxide, propylene oxide, butylene oxide, and tetrahydrofuran. The alkylene oxide may be used either singly or in combination of 2 or more types. When it is used in combination of 2 or more types, the addition polymerization may be performed either in random shape or block shape. Among them, tetrahydrofuran is preferable, and the average addition mole number of alkylene oxide is 1 to 20, and preferably 2 to 12.

As for the method for producing the (meth)acrylate (P1) component having an alkylene oxide skeleton, the same method as a common ring opening reaction can be performed. For example, after adding (meth)acrylate having 1 hydroxyl group and 3 or more (meth)acryloyl groups in the molecule, a catalyst, and if necessary, a polymerization inhibitor and an organic solvent to a reaction vessel, inside of the reaction vessel is replaced with inert gas like nitrogen gas, and after adding alkylene oxide under pressure, the addition polymerization is carried out. The reaction temperature is generally −30 to 120° C., preferably 0 to 80° C., and more preferably 20 to 60° C. If it is lower than −30° C., the reaction rate becomes slow. On the other hand, if it is higher than 120° C., a side reaction or the polymerization progresses excessively, or the product may be colored. The reaction time is generally 0.3 to 20 hours and more preferably 1 to 10 hours.

The polyisocyanate (P2) is aliphatic, alicyclic or aromatic isocyanate which has at least 2 isocyanate groups in the molecule. Specific examples of a bifunctional isocyanate include aromatic diisocyanate such as 1,4-tolylene diisocyanate, 2,4-tolylene diisocyanate, 2,6-tolylene diisocyanate, 1,3-xylylene diisocyanate, 1,5-naphthalene diisocyanate, or 4,4′-diphenylmethane diisocyanate and aliphatic and alicyclic diisocyanate such as trimethylene diisocyanate, hexamethylene diisocyanate, 1,4-cyclohexane diisocyanate, dicyclohexylmethane diisocyanate, isophorone diisocyanate, or norbornane diisocyanate. Examples of a trifunctional isocyanate include isocyanurate in which diisocyanate such as 1,4-tolylene diisocyanate, 2,4-tolylene diisocyanate, 2,6-tolylene diisocyanate, 1,3-xylylene diisocyanate, hexamethylene diisocyanate, dicyclohexylmethane diisocyanate, isophorone diisocyanate, or norbornane diisocyanate is subjected to condensation polymerization followed by isocyanurate modification, an adduct obtained by adduct modification of the diisocyanate, and a biuret product obtained by biuret modification of the diisocyanate and trihydric alcohol like glycerin and trimethylol propane. Specific examples of a polyfunctional isocyanate include an isocyanate compound which is obtained by reacting the diisocyanate and polyol or polyamine.

Among them, trifunctional isocyanate which is obtained by condensation polymerization of aliphatic diisocyanate and alicyclic diisocyanate, aliphatic diisocyanate and alicyclic diisocyanate monomer followed by modification is preferable. More preferably, it is trifunctional isocyanate which is obtained by modification of aliphatic and alicyclic diisocyanate such as hexamethylene diisocyanate, dicyclohexylmethane diisocyanate, isophorone diisocyanate, or norbornane diisocyanate and isocyanurate of those diisocyanates. The polyisocyanate may be used either singly or in combination of 2 or more types.

Synthetic Examples are given hereinbelow.

To a stainless autoclave equipped with a stirrer, a thermometer, and a pressure gauge, 307 parts by mass of a mixture of pentaerythritol triacrylate (hereinbelow, described as “PE3A”)/pentaerythritol tetraacrylate (hereinbelow, described as “PE4A”) (i.e., mixture with mass ratio of 70/30, hydroxyl group number: 137 mgKOH/g), 0.1 part by mass of hydroquinone monomethyl ether, and 3.2 parts by mass of tin tetrachloride were added, and the inside of the reaction system was replaced with nitrogen gas. Next, 100 parts by mass of ethylene oxide (hereinbelow, described as “EO”) were added over 3 hours while the gauge pressure is maintained at 0.1 to 0.3 MPa at 45° C., and the reaction was allowed to occur for 2 hours at the same temperature. Furthermore, after reducing the pressure at 45° C. and maintaining it for 30 minutes, the pressure was brought back to normal pressure followed by cooling to obtain 402 parts by mass of viscous liquid. After that, an adsorbent (KYOWADO 1000: product of Kyowa Chemical Industry Co., Ltd.) was added and stirred at 70° C. under flushing with air. By removing the adsorbent by filtration, 370 parts of viscous liquid were obtained. The hydroxyl group number of the obtained viscous liquid was 106 mgKOH/g, and when calculated from the hydroxyl group number, (meth)acrylate with number average molecular weight of 430 in which 3 moles of EO are added to PE3A was obtained, and the mass ratio of the mixture of 3 mole EO adduct of PE3A/PE4A was 77/23.

Furthermore, examples of the active ray curable resin include, other than those described above, a UV curable acrylate based resin, a UV curable urethane acrylate based resin, a UV curable polyester acrylate based resin, a UV curable epoxy acrylate based resin, a UV curable polyol acrylate based resin, and a UV curable epoxy resin.

Among them, as the self-restoring layer according to the present invention, polyrotaxane may be used as other active ray curable resin. Examples of a commercially available polyrotaxane product which may be preferably used include SM3405P, SM1315P, SA3405P, SA2405P, SA1315P, SM3400C, SA3400C, and SA2400C (all manufactured by Advanced Softmaterials, Inc).

Furthermore, a commercially available polyrotaxane product like SH3400P, SH2400P, and SH1310P, even though they are a thermosetting resin, and SH3400S and SH3400M as a thermosetting elastomer (all manufactured by Advanced Softmaterials, Inc) may be also preferably used as a commercially available polyrotaxane product.

(Photopolymerization Initiator)

It is also preferable that a photopolymerization initiator is contained in the self-restoring layer to promote curing of the active ray curable resin. Amount of the photopolymerization initiator is, in terms of mass ratio, preferably as follows—photopolymerization initiator:active ray curable resin=20:100 to 0.01:100. Specific examples of the photopolymerization initiator include alkylphenone based, acetophenone, benzophenone, hydroxybenzophenone, Michler's ketone, α-amyloxime ester, thioxanthone, and derivatives thereof, but not particularly limited thereto.

As for the photopolymerization initiator, a commercially available product may be used, and preferred examples thereof include IRGACURE184, IRGACURE907, and IRGACURE651 that are manufactured by BASF Japan.

(Additives)

In the self-restoring layer, additives such as silicone based surface active agent, fluorine-based surface active agent, anionic surface active agent, fluorine-siloxane graft compound, fluorine based compound, or acrylic copolymer may be contained.

(Microparticles)

Microparticles (i.e., mattifying agent) may be further contained in order to enhance the sliding property on a surface of the self-restoring layer.

The microparticles may be either inorganic microparticles or organic microparticles. Examples of the inorganic microparticles include silicon dioxide (silica), titan dioxide, aluminum oxide, zirconium oxide, calcium carbonate, calcium carbonate, talc, clay, calcined kaolin, calcined calcium silicate, hydrous calcium silicate, aluminum silicate, magnesium silicate and calcium phosphate. Among them, silicon dioxide and zirconium oxide are preferable. To reduce an increase in haze of a film to be obtained, it is more preferably silicon dioxide.

Examples of the microparticles of silicon dioxide include Aerosil R972, R972V, R974, R812, 200, 200V, 300, R202, OX50, TT600, NAX50 (all manufactured by Japan Aerosil), and Seahostar KE-P10, KE-P30, KE-P50, KE-P100 (all manufactured by Nippon Shokubai Co., Ltd.). Among them, Aerosil R972V, NAX50, Seahostar KE-P30 and the like are particularly preferable in that the friction coefficient can be lowered while maintaining the turbidity of a self-restoring layer to be obtained at low level.

Primary particle diameter of the microparticles is preferably in a range of 5 to 50 nm, and more preferably in a range of 7 to 20 nm. A higher primary particle diameter has a larger effect of increasing the sliding property, but the transparency may be easily compromised. As such, it is also possible that the microparticles are contained as a secondary aggregate with particle diameter range of 0.05 to 0.3 wn. Size of the primary particle of microparticles or the secondary aggregate thereof can be obtained by observing the primary particle or the secondary aggregate under a transmission electron microscope at magnification 500,000 to 2,000,000 and obtaining the average value of the particle diameter of 100 primary particles or secondary aggregates.

Content of the microparticles is, relative to the resin for forming the self-restoring layer, preferably in a range of 0.05 to 1.0% by mass, and more preferably in a range of 0.1 to 0.8% by mass.

(Solvent)

The self-restoring layer is preferably formed, according to the following method, by applying, drying, and curing via a buffer layer described below, a self-restoring layer composition which is prepared by diluting the above components with a solvent, on a light reflecting body.

Preferred examples of the solvent include ketone (methyl ethyl ketone, acetone, or the like) and/or acetic acid ester (methyl acetate, ethyl acetate, butyl acetate, or the like), alcohol (ethanol, methanol, or the like), propylene glycol monomethyl ether, cyclohexanone, and methyl isobutyl ketone. Thickness of a dry layer in the self-restoring layer is preferably in a range of 5 to 30 μm in terms of average layer thickness. It is more preferably in a range of 10 to 20 μm. When it is within such range, the self-restoring property can be exhibited and the scratch resistance is improved.

As for the method for coating the self-restoring layer, a well-known method using Gravure coater, dipping coater, reverse coater, wire bar coater, die coater, and an inkjet method can be used.

(Method for Forming Self-Restoring Layer)

After applying a composition for the self-restoring layer, it is dried, cured (i.e., irradiated with active ray (also referred to as UV curing treatment)), and if necessary, subjected to a heating treatment after UV curing. The heating treatment temperature after UV curing is preferably 80° C. or higher, more preferably 100° C. or higher, and particularly preferably 120° C. or higher. By performing the heating treatment after UV curing at such high temperature, a self-restoring layer with excellent film strength can be obtained.

As for the drying, it is preferable that the drying temperature for less than 15 seconds after the above coating step is in a range of 15 to 70° C., the drying temperature for 15 seconds or longer but less than 36 seconds is in a range of 60 to 120° C., and the drying temperature for 36 seconds or longer but less than 40 seconds is in a range of 30 to 80° C.

Irradiation conditions may vary depending on each lamp. However, irradiation amount of active ray is generally in a range of 30 to 1000 mJ/cm², and preferably in a range of 70 to 300 mJ/cm². Furthermore, to prevent an inhibited reaction caused by oxygen, oxygen removal (for example, replacement with inert gas like nitrogen purge) may be performed for the UV curing treatment. By adjusting the removal amount of oxygen concentration, the curing state on surface can be controlled.

To improve flatness, it is preferable to perform the irradiation with active energy under application of tension on a light reflecting body.

[2] Buffer Layer

The buffer layer according to the present invention is characterized in that it includes a polymer which is polymerized from a monomer composition containing at least one selected from UV stable monomers and at least one selected from UV absorbing monomers and also ratio of an uncured monomer in the buffer layer before decorative molding is 5% by mass or more to increase the elastic range of the self-restoring layer. The ratio of an uncured monomer in the buffer layer before decorative molding is preferably in a range of 5 to 80% by mass, and more preferably in a range of 5 to 60% by mass. As it is 5% by mass or more, the buffering property is enhanced so that favorable stress alleviation is obtained at the time of attaching on a curved surface. The ratio of 80% by mass or less is more effective for preventing plasticization of the self-restoring layer.

Furthermore, the ratio of an uncured monomer in the buffer layer after decorative molding is preferably 3% by mass or less. As it is 3% by mass or less, the buffer layer can be cured and deformation of the buffer layer occurring at the time of application of external stress can be suppressed and also deterioration of optical reflectance can be prevented.

The polymer which may be used for the buffer layer is preferably a polymerizable acrylic polymer which is polymerized from a monomer composition containing at least one selected from UV stable monomers and at least one selected from UV absorbing monomers. By using this compound in the buffer layer, the self-restoring property and scratch resistance of a self-restoring layer can be increased and also light resistance of an entire light reflecting film can be enhanced compared to a case in which a self-restoring layer is used after adding a UV absorbing agent or a photostabilizer.

The UV stable monomer mentioned in the present invention indicates a compound which is generally referred to as HALS (hindered amine type photostabilizer), and it is preferably a UV stable monomer represented by the following Formula (1) or (2). More preferably, it has a polymerizable double bond on a side chain of a polymer that is obtained by radical polymerization of a monomer composition containing at least one selected from the monomers.

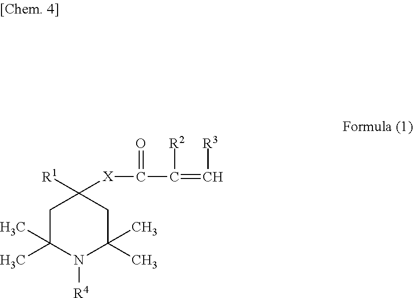

(in the formula, R¹ is a hydrogen atom or a cyano group. R² and R³ each independently represent a hydrogen atom or a methyl group. R⁴ represents a hydrogen atom or a hydrocarbon group with 1 to 18 carbon atoms, and X represents an oxygen atom or an imino group).

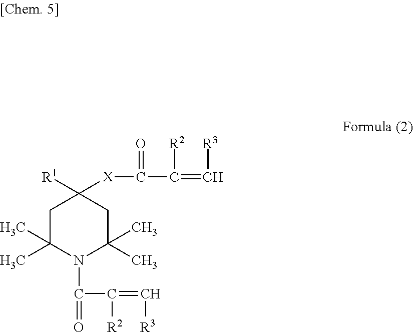

(in the formula, R¹ is a hydrogen atom or a cyano group. R² and R³ each independently represent a hydrogen atom or a methyl group, and X represents an oxygen atom or an imino group). It is also preferable that, in the polymer according to the present invention, the monomer composition contains at least one selected from UV absorbing monomers represented by the following Formula (3) or (4) and a monomer represented by the Formula (5).

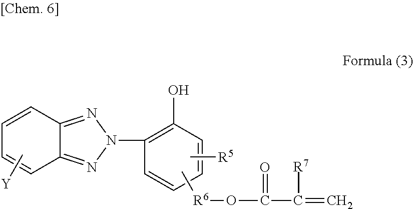

(in the formula, R⁵ is a hydrogen atom or a hydrocarbon group with 1 to 8 carbon atoms. R⁶ represents a lower alkylene group. R⁷ represents a hydrogen atom or a methyl group. Y represents a hydrogen, a halogen, a hydrocarbon group with 1 to 8 carbon atoms, a lower alkoxy group, a cyano group, or a nitro group).

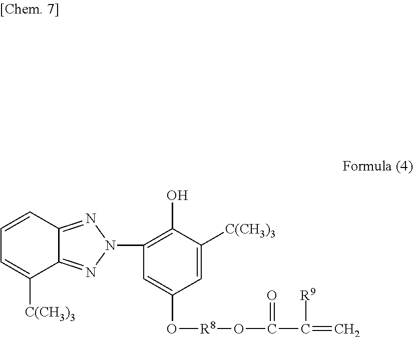

(in the formula, R⁸ represents an alkylene group with 2 to 3 carbon atoms. R⁹ represents a hydrogen atom or a methyl group).

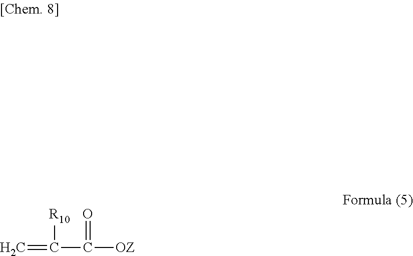

(in the formula, R¹⁹ represents a hydrogen atom or a methyl group. Z represents a cycloalkyl group which may have a substituent group). The polymerizable acryl polymer used for the buffer layer according to the present invention is preferably produced by reacting the polymer which is obtained by radical polymerization of a monomer composition containing at least one selected from UV stable monomers represented by the Formula (1) or (2) and a monomer having a functional group with a compound having a functional group capable of reacting with the functional group of the monomer and a polymerizable double bond.

By containing the UV stable monomer with specific structure described above, the polymerizable acryl polymer used for the buffer layer exhibits excellent light resistance. Although the working mechanism is not clearly defined yet, it is believed that main mechanism is involved with capturing of an alkyl radical generated according to photoinitiation reaction of the polymer by the N-oxy radical generated according to oxidation of the N-substituent group in the piperidine skeleton.

Furthermore, when a polymerizable UV stabilizer is used like a conventional technology, problems like bleed out of a UV stabilizer from a polymerization composition can be solved. Furthermore, as the polymer has a polymerizable double bond on a side chain, it is a self-crosslinking polymer with excellent scratch resistance. Furthermore, as being an acryl polymer, a balance in physical properties can be easily achieved based on the length of a side chain alkyl group of a monomer to be copolymerized or the presence or absence of an aromatic ring.

Furthermore, if the above polymerizable acryl polymer is used in combination with a UV absorbing monomer with specific structure represented by the Formula (3) or (4), a significant synergistic effect can be obtained in terms of light resistance. It is also possible to further contain an unsaturated monomer with specific structure. As the unsaturated monomer has a bulky substituent, it has an effect of alleviating internal stress in a coating film regarding a curing method which easily causes internal deformation in a coating film like curing by electron beam or UV ray. Thus, no crack occurs in the coating film and long term light resistance is further improved.

The UV stable monomer of the Formula (1) or (2) which is used in the present invention is piperidines in which the substituent group represented by R¹ is a hydrogen atom or a cyano group, the substituent groups represented by R² and R³ each independently represent a hydrogen atom or a methyl group, the substituent group represented by R⁴ represents a hydrogen atom or a hydrocarbon group with 1 to 18 carbon atoms, and the substituent group represented by X represents an oxygen atom or an imino group in the formula.

Specific examples of the substituent group represented by R⁴ include a hydrogen atom; a chain type hydrocarbon group such as a methyl group, an ethyl group, a propyl group, an isopropyl group, a butyl group, an isobutyl group, a t-butyl group, a pentyl group, a hexyl group, a heptyl group, an octyl group, a nonyl group, a decyl group, a undecyl group, a dodecyl group, a tridecyl group, a tetradecyl group, a pentadecyl group, a hexadecyl group, a heptadecyl group, or an octadecyl group; an alicyclic hydrocarbon group such as a cyclopropyl group, a cyclopentyl group, a cyclohexyl group, a cycloheptyl group, or a cyclooctyl group; and an aromatic hydrocarbon group such as a phenyl group, a tolyl group, a xylyl group, a benzyl group, or a phenethyl group.

Specific examples of the UV stable monomer represented by the above Formula (1) include 4-(meth)acryloyloxy-2,2,6,6-tetramethyl piperidine, 4-(meth)acryloyl amino-2,2,6,6-tetramethyl piperidine, 4-(meth)acryloyloxy-1,2,2,6,6-pentamethylpyridine, 4-(meth)acryloyl amino-1,2,2,6,6-pentamethylpyridine, 4-cyano-4-(meth)acryloyl amino-2,2,6,6-tetramethyl piperidine, 4-crotonoyloxy-2,2,6,6-tetramethyl piperidine, and 4-crotonoylamino-2,2,6,6-tetramethyl piperidine, and it may be used either singly or as a suitable mixture of two or more types. It is evident that the UV stable monomer of the Formula (1) is not limited to those compounds.

Specific examples of the UV stable monomer represented by the above Formula (2) include 1-(meth)acryloyl-4-(meth)acryloyl amino-2,2,6,6-tetramethyl piperidine, 1-(meth)acryloyl-4-cyano-4-(meth)acryloyl amino-2,2,6,6-tetramethyl piperidine, and 1-crotonoyl-4-croctoyloxy-2,2,6,6-tetramethyl piperidine, and it may be used either singly or as a suitable mixture of two or more types. It is evident that the UV stable monomer of the Formula (2) is not limited to those compounds.

The UV absorbing monomer represented by the above Formula (3) of the present invention is benzotriazoles in which R⁵ is a hydrogen atom or a hydrocarbon group with 1 to 8 carbon atoms, R⁶ is a lower alkylene group, R⁷ represents a hydrogen atom or a methyl group, and Y represents hydrogen, a halogen, a hydrocarbon group with 1 to 8 carbon atoms, a lower alkoxy group, a cyano group, or a nitro group in the formula.

In the above formula, the substituent group represented by R⁵ is specifically a hydrogen atom; a chain type hydrocarbon group such as a methyl group, an ethyl group, a propyl group, an isopropyl group, a butyl group, an isobutyl group, a t-butyl group, a pentyl group, a hexyl group, a heptyl group, and an octyl group; an alicyclic hydrocarbon group such as a cyclopropyl group, a cyclopentyl group, a cyclohexyl group, a cycloheptyl group, or a cyclooctyl group; and an aromatic hydrocarbon group such as a phenyl group, a tolyl group, a xylyl group, a benzyl group, or a phenethyl group. The substituent group represented by R⁶ is specifically, an alkylene group with 1 to 6 carbon atoms including a linear type alkylene group such as a methylene group, an ethylene group, a propylene group, a butylene group, a pentylene group, or a hexylene group and a branch type alkylene group such as an isopropylene group, an isobutylene group, a s-butylene, t-butylene group, an isopentylene group, or a neopentylene group. The substituent group represented by Y is a hydrogen; a halogen such as fluorine, chlorine, bromine, or iodine; a chain type hydrocarbon group such as a methyl group, an ethyl group, a propyl group, an isopropyl group, a butyl group, an isobutyl group, a t-butyl group, a pentyl group, a hexyl group, a heptyl group, or an octyl group; an alicyclic hydrocarbon group such as a cyclopropyl group, a cyclopentyl group, a cyclohexyl group, a cycloheptyl group, or a cyclooctyl group; an aromatic hydrocarbon group such as a phenyl group, a tolyl group, a xylyl group, a benzyl group, or a phenethyl group; a lower alkoxy group with 1 to 6 carbon atoms such as a methoxy group, an ethoxy group, a propoxy group, a butoxy group, a pentoxy group, or a heptoxy group; a cyano group; and a nitro group.

Specific examples of the UV absorbing monomer represented by the above Formula (3) include 2-[2′-hydroxy-5′-(methacryloyloxymethyl)phenyl]-2H-benzotriazole, 2-[[2′-hydroxy-5′-(methacryloyloxyethyl)phenyl]]-2H-benzotriazole, 2-[2′-hydroxy-3′-t-butyl-5′-(methacryloyloxyethyl)phenyl]-2H-benzotriazole, 2-[2′-hydroxy-5′-t-butyl-3′-(methacryloyloxyethyl)phenyl]-2H-benzotriazole, 2-[2′-hydroxy-5′-(methacryloyloxyethyl)phenyl]-5-chloro-2H-benzotriazole, 2-[2′-hydroxy-5′-(methacryloyloxyethyl)phenyl]-5-methoxy-2H-benzotriazole, 2-[2′-hydroxy-5′-(methacryloyloxyethyl)phenyl]-5-cyano-2H-benzotriazole, 2-[2′-hydroxy-5′-(methacryloyloxyethyl)phenyl]-t-butyl-2H-benzotriazole, and 2-[2′-hydroxy-5′-(methacryloyloxyethyl)phenyl]-5-nitro-2H-benzotriazole, but are not particularly limited thereto. The UV absorbing monomer represented by the Formula (3) may be used either singly or as a suitable mixture of two or more types.

Furthermore, the UV absorbing monomer represented by the above Formula (4) is benzotriazoles in which the substituent group represented by R⁸ is an alkylene group with 2 or 3 carbon atoms and R⁹ is a hydrogen atom or a methyl group in the formula.

Specific examples of the substituent group represented by R⁸ in the formula include an ethylene group, a trimethylene group, and a propylene group.

Examples of the UV absorbing monomer represented by the above Formula (4) include 2-[2′hydroxy-5′-(β-methacryloyloxyethoxy)-3′-t-butylphenyl]-4-t-butyl-2H-benzotriazole, but not particularly limited thereto. The UV absorbing monomer represented by the Formula (4) may be used either singly or as a suitable mixture of two or more types.

The unsaturated monomer represented by the Formula (5), which is used for the present invention, is an unsaturated monomer in which the substituent group represented by R¹⁰ is a hydrogen atom or a methyl group and the substituent group represented by Z is a cycloalkyl group which may have a substituent group in the formula.

In the formula, examples of the substituent group represented by Z include a cyclohexyl group, a methylcyclohexyl group, a t-butylcyclohexyl group, and a cyclododecyl group.

Specific examples of the unsaturated monomer represented by the Formula (5), which is used for the present invention, include cyclohexyl (meth)acrylate, methylcyclohexyl (meth)acrylate, t-butylcyclohexyl (meth)acrylate, cyclododecyl (meth)acrylate, and one or two or more of them may be used.

The polymerizable acryl monomer used for the present invention may be a copolymerization polymer which has an acryl monomer as a main monomer and has other copolymerizable unsaturated monomer.

As for the acryl based monomer used in the present invention, an acryl based carboxylic acid such as (meth)acrylic acid; (meth)acrylic acid ester such as methyl (meth)acrylate, ethyl (meth)acrylate, n-propyl (meth)acrylate, isopropyl (meth)acrylate, n-butyl (meth)acrylate, t-butyl (meth)acrylate, 2-ethylhexyl (meth)acrylate, or lauryltridecyl (meth)acrylate; (meth)acrylic acid ester containing hydroxyl group such as 2-hydroxyethyl (meth)acrylate, 2-hydroxypropyl (meth)acrylate, hydroxy (meth)acrylate modified with caprolactone (for example, “Praxel FM” manufactured by Daicel Corporation), or (meth)acrylic acid monoester of ester diol which is obtained from phthalic acid and propylene glycol; and other acryl based monomer such as (meth)acrylonitrile, (meth)acrylamide, N-methylol acrylamide, N-butoxymethyl acrylamide, diacetoneacrylamide, 2-sulfonic acid ethyl (meth)acrylate, imide (meth)acrylate and a salt thereof, and one or two or more types of them are used. Among them, from the viewpoint of adhesiveness to the light reflecting body, imide (meth)acrylate may be suitably used.

As for the other copolymerizable unsaturated monomer, an unsaturated monomer containing halogen such as vinyl chloride or vinylidene chloride; an aromatic unsaturated monomer such as styrene, α-methylstyrene, or vinyl toluene; a vinyl ester such as vinyl acetate; and vinyl ether may be mentioned. If necessary, one or two or more types of them may be used.

Use amount of various monomers is not particularly limited. However, the total use amount of the UV stable monomer represented by the Formula (1) or (2) is required to be 0.1 to 30% by mass relative to the whole amount of the polymer composition. More preferred range is described as follows: the lower limit is preferably 0.5% by mass, and more preferably 1% by mass, and the upper limit is preferably 20% by mass, and more preferably 15% by mass. When the total use amount of the UV stable monomer is within this range, a sufficient light resistance of the polymerizable acryl polymer can be obtained.

The total use amount of the UV absorbing monomer represented by the Formula (3) or (4) is required to be 0.1 to 30% by mass relative to the whole amount of the polymer composition. More preferred range is described as follows: the lower limit is preferably 0.5% by mass, and more preferably 1% by mass, and the upper limit is preferably 20% by mass, and more preferably 15% by mass. When it is within this range, the synergistic effect with the UV stable monomer becomes sufficient and a sufficient light resistance can be obtained. Furthermore, there is no concern regarding the cause of coloration.

The use amount of the unsaturated monomer represented by the Formula (5) is required to be 5 to 80% by mass relative to the whole amount of the polymer composition. More preferred range is described as follows: the lower limit is preferably 10% by mass, and more preferably 15% by mass, and the upper limit is preferably 70% by mass, and more preferably 50% by mass. When it is within this range, it is not likely to have an occurrence of cracks during curing, a sufficient light resistance can be obtained, and there is no concern of having a weak cured coating film.

The polymerizable acryl polymer of the present invention can be produced by reacting the polymer, which is obtained by radical polymerization of a monomer composition containing at least one selected from UV stable monomers represented by the Formula (1) or (2) and a monomer having a functional group, with a compound having a functional group capable of reacting with the functional group of the monomer and a polymerizable double bond.

Specific examples of the functional group used for introducing a polymerizable double bond include an epoxy group, an oxazoline group, an isocyanate group, an acid amide group (aminocarbonyl group), a carboxy group, a hydroxyl group, and an amino group. Specific examples of the polymerizable monomer having those functional groups include glycidyl (meth)acrylate, 2-isopropenyl-2-oxazoline, 4-epoxycyclohexyl methyl (meth)acrylate, ethyl isocyanate (meth)acrylate, N-acrylamide, N-methoxymethyl acrylamide, N-butoxymethyl acrylamide, itaconic acid diamide, fumaric acid amide, phthalic acid amide, (meth)acrylate, itaconic acid, fumaric acid, maleic acid, 2-hydroxyethyl (meth)acrylate, 2-hydroxypropyl (meth)acrylate, dimethylaminoethyl (meth)acrylate, and t-butylaminoethyl (meth)acrylate.

Specific examples of a compound which is used for introducing the polymerizable functional group include, in a case in which the functional group is an epoxy group or an oxazoline group, a compound having a carboxy group such as (meth)acrylic acid or itaconic acid; in a case in which the functional group is an isocyanate group, a monomer containing a hydroxyl group such as 2-hydroxyethyl (meth)acrylate, 2-hydroxypropyl (meth)acrylate, or 4-hydroxybutyl (meth)acrylate; in a case in which the functional group is a carboxy group, a monomer containing an epoxy group such as glycidyl (meth)acrylate, 2-isopropenyl-2-oxazoline, or 4-epoxycyclohexyl methyl (meth)acrylate, and a monomer containing a hydroxyl group such as 2-hydroxyethyl (meth)acrylate, 2-hydroxypropyl (meth)acrylate, or 4-hydroxybutyl (meth)acrylate; in a case in which the functional group is a hydroxyl group, a monomer containing an isocyanate group such as ethyl isocyanate (meth)acrylate and a monomer containing a carboxy group such as (meth)acrylate, or itaconic acid; in a case in which the functional group is an acid amide group, a monomer containing an epoxy group or a hydroxyl group such as glycidyl (meth)acrylate, 4-epoxycyclohexyl methyl (meth)acrylate, or 2-hydroxyethyl (meth)acrylate; and in a case in which the functional group is an amino group, a monomer containing a carboxy group such as (meth)acrylic acid.

It is favorable that the double bond equivalent of the acryl polymer of the present invention is 200 to 3000. It is preferably 300 to 1500, and more preferably 350 to 1000. When the double bond equivalent is 3000 or less, sufficient hardness and scratch resistance are obtained. On the other hand, if it is 200 or more, it is unlikely to have an occurrence of cracks over time in a cured coating film so that the light resistance is improved.

Furthermore, the polymerization method for copolymerizing the monomer components is not particularly limited, and a conventionally known polymerization method may be adopted. For example, a polymerization method such as a solution polymerization, a dispersion polymerization, a suspension polymerization, or an emulsion polymerization may be used. Examples of a solvent which may be used for polymerizing the monomer components by using a solution polymerization include an aromatic solvent like toluene, xylene, and other aromatic solvent with high boiling point; an ester solvent such as butyl acetate, ethyl acetate, or cellosolve acetate; and a ketone solvent such as methyl ethyl ketone or methyl isobutyl ketone. It is needless to say that the usable solvent is not limited to those solvents. The solvent may be used either singly or in combination of two or more types. Furthermore, the use amount of the solvent can be suitably set in consideration of concentration of a product or the like.

For copolymerizing the monomer composition, a polymerization initiator is used. Examples of the polymerization initiator include a common radical polymerization initiator such as 2,2′-azobis-(2-methyl butyronitrile), t-butylperoxy-2-ethyl hexanoate, 2,2′-azobisisobutyronitrile, or benzoyl peroxide, di-t-butyl peroxide. Use amount of the polymerization initiator needs to be suitably determined based on characteristic property value of a desired polymer or the like. Although it is not particularly limited, it is preferably in a range of 0.01 to 50% by mass, and more preferably in a range of 0.05 to 20% by mass relative to the whole amount of the monomer components.

The reaction temperature is not particularly limited. However, it is preferably in a range of room temperature to 200° C., and more preferably in a range of 40 to 140° C. Meanwhile, the reaction time may be suitably determined to have a complete polymerization reaction depending on the composition of a monomer composition to be used or the type of a polymerization initiator.

(Other Components of Buffer Layer)

As for the other components constituting the buffer layer, a curing agent, a curing promoter, and other additives may be used. In detail, the same materials as those described in JP 2009-269984 A may be mentioned, for example, but it is not limited thereto.

(Method for Producing Buffer Layer)

With regard to forming of the buffer layer, it is preferable that the polymer and, if necessary, various additives are dissolved in an organic solvent or the like to give a coating solution of buffer layer, and the coating solution is applied on a light reflecting body. Coating may be carried out by a method like impregnation, spray, brushing, curtain flow coat, roll coat, spin coat, and bar coat.

Layer thickness of the buffer layer is, although not particularly limited, preferably in a range of 1 to 10 μm, and more preferably in a range of 3 to 7 μm. As it is within this range, stress from an outside of the self-restoring layer can be alleviated in the buffer layer, and by broadening the elastic deformation range of the self-restoring layer, scratch resistance can be improved while the self-restoring property against even stronger stress from an outside is maintained.

Curing of the polymerizable acryl polymer is preferably performed by heating, and after applying the buffer coating solution on a light reflecting body, it is thermally cured. It is preferable to perform the curing in a temperature range of 80 to 200° C. by suitably adjusting the type of the polymer and a ratio of a curing agent, a curing promoter, or the like. The temperature range is more preferably 80 to 150° C., and the temperature range is even more preferably 80 to 120° C. Time for thermal curing is suitably controlled. However, for adjusting the ratio of an uncured monomer and maintaining the mechanical strength of a buffer layer, the range of 0.5 to 10 minutes is preferable.

The buffer layer according to the present invention has an effect of broadening the elastic deformation range of self-restoring layer when the ratio of an uncured monomer in the buffer layer before decorative molding is 5% by mass or more. Accordingly, from the viewpoint of improving the scratch resistance before decorative molding and during handling for decorative molding like attachment after stretching of the light reflecting film of the present invention to a curve surface shape, it is preferable that the monomer components are intentionally left, it is preferable that the temperature and time for thermal curing are controlled within the above range, and it is preferable that the self-restoring layer is formed on the buffer layer without performing a post heating step like aging after thermal curing.

That is, it is preferable that the method for producing the light reflecting film of the present invention is carried out as follows: a buffer layer coating solution for forming the buffer layer is applied on the light reflecting body followed by thermal curing, and without performing an aging treatment, a self-restoring layer is formed on the buffer layer. The aging treatment described herein means long-term heating at relative low temperature after forming the buffer layer, and although it cannot be uniformly described since it includes combination of heating temperature or heating time, it indicates a heating treatment that is performed within a range of 0.5 to 7 days in the temperature range of 35 to 50° C., for example.

Furthermore, it is also possible that, after forming the self-restoring layer, an aging treatment is performed for the light reflecting film with an intention of promoting the curing of the self-restoring layer. However, in that case, the treatment is carried out at relative mild conditions for aging treatment like having 5% by mass or more of the ratio of uncured monomer in the buffer layer before decorative molding.

The ratio of uncured monomer before decorative molding is preferably in a range of 5 to 80% by mass, and more preferably in a range of 5 to 60% by mass. As it is 5% by mass or more, the buffer property is increased so that favorable stress alleviation is obtained at the time of attaching to a curved surface body, and when it is 80% by mass or less, it is more effective for preventing plasticization of the self-restoring layer.

Furthermore, the ratio of uncured monomer after decorative molding is preferably 3% by mass or less. To adjust it to this range, the temperature for decorative molding is preferably 80° C. or higher, and it is preferably in the temperature range of 80 to 200° C. More preferably, it is in the temperature range of 80 to 150° C., and even more preferably in the temperature range of 80 to 120° C. The time for decorative molding is preferably adjusted to have the above ratio of uncured monomers.

By carrying out the decorative molding within the above temperature and time range, the ratio of uncured monomer after decorative molding is preferably controlled to 0.1 to 3% by mass or less, and more preferably in a range of 0.1 to 1.0% by mass. If the ratio of uncured monomer after decorative molding is 0.1% by mass or more, the scratch resistance after molding is high, and if the ratio is 3% by mass or less, the light resistance after molding is improved.

As the ratio of uncured monomer in the buffer layer before and after decorative molding is controlled to the above-described specific range, the elastic deformation range of the self-restoring layer can be broadened, and it is believed that, even for a case of decorative molding like stretching and attachment of the light reflecting film of the present invention to a curved surface shape, a deformation stress from a substrate during or after molding can be absorbed and a deterioration in the scratch resistance of a stretch part of the self-restoring layer can be suppressed.

<Method for Quantifying Uncured Monomer in Buffer Layer>

Content of the uncured monomer in the buffer layer can be measured according to the following method.

A sample of the light reflecting film is cut and measured for ATR (Attenuated Total Reflection) of the buffer layer. As an ATR device, FT/IR-4100 (manufactured by JASCO Corporation) can be used, for example.

(Methods and Data Processing)

A sample of the light reflecting film is cut and the solid content of the resulting buffer layer is measured by ATR in the wave number range of 400⁻¹ to 6000 cm⁻¹. The reflected light intensity R1 and R2 at each wave number described below are obtained.

R1: Reflected light intensity at 2270 cm⁻¹: it is a peak of an isocyanate bond, which corresponds to a peak of an uncured component.

R2: Reflected light intensity at 2950 cm⁻¹: it is a peak of a C—H bond, which corresponds to a peak of a material itself (does not vary depending on curing/uncuring).

By calculating R1/R2, the uncured component can be quantified.

Herein, A: R1/R2 after coating buffer layer; thermosetting resin has 100% of uncured monomer at a stage at which the solvent is vaporized after coating.

B: R1/R2 after curing treatment for 30 minutes at 150° C. following coating of buffer layer; thermosetting resin has 0% of uncured monomer as a result of complete curing.

From the above data, the ratio of uncured monomer, i.e., MM, can be obtained based on the following formula.

(Ratio MM of uncured monomer (% by mass))=(R1/R2−B)/(A−B)×100

In the above formula, (R1/R2−B) indicates a value which is obtained by subtracting the base intensity from R1/R2 at the time of measurement.

(A−B) indicates the entire monomer amount (i.e., total amount of polymer and monomer).

As such, (R1/R2−B)/(A−B) represents (amount of uncured monomer)/(entire monomer amount) at the time of measurement.

[3] Light Reflecting Body

The light reflecting body according to the present invention is provided as a light reflecting film by laminating, as an upper layer, the buffer layer and the self-restoring layer of the present invention. The light reflecting film preferably has light reflectance which is 50% or more in the light wavelength range of 1000 to 1500 nm. Furthermore, as a light reflecting film of other mode, it is preferable that light reflectance is 50% or more in the light wavelength range of 450 to 650 nm.

The former indicates a general name of an IR reflecting film which typically selectively reflects IR ray, and the latter indicates a general name of a reflecting film (also referred to as film mirror) or a glossy film (also referred to as metal gloss film) which selectively reflects visible ray, and there are various types for each of them.

Hereinbelow, an IR reflecting film to be attached on a window, a reflecting film (film mirror) for solar heat reflection, and a metal gloss film, which are preferred embodiments of the light reflecting body according to the present invention, are described in detail.

[3.1] IR Reflecting Film

With regard to the optical characteristics of an IR reflecting film as the light reflecting body of the present invention, the visible light transmittance measured by JIS R3106 (1998) is preferably 60% or more, more preferably 70% or more, and even more preferably 80% or more. Furthermore, the reflectance in near IR to IR region with wavelength of 1000 to 1500 nm is preferably 50% or more, more preferably 70% or more, even more preferably 80% or more, and particularly preferably 90% or more. The reflectance of the IR reflecting film is measured in a range of 1000 to 1500 nm by using a spectrophotometer (using integrating sphere, Model U-4000, manufactured by Hitachi High Technologies Corporation) in an environment of 23° C., 55% RH. The mean reflectance is obtained and used as IR reflectance.

Furthermore, total thickness of the IR reflecting film is not particularly limited, but it is preferably in a range of 100 to 1500 μm, more preferably in a range of 100 to 1000 μm, even more preferably in a range of 100 to 700 μm, and particularly preferably in a range of 100 to 500 μm.

An example of the representative configuration of the IR reflecting film is described with an aid of drawings.

As a functional layer, the IR reflecting film preferably has an infrared reflecting layer which has a function of reflecting 80% or more, and more preferably 90% or more of the light within the light wavelength range of 1000 to 1500 nm as a functional layer. Further, it is preferably a configuration in which the infrared reflecting layer is a laminate of a reflecting layer for reflecting selectively the light with specific wavelength in which a high refractive index reflecting layer containing a first water soluble binder resin and a first metal oxide particle and a low refractive index reflecting layer containing a second water soluble binder resin and a second metal oxide particle are alternately laminated.

The layer configuration of the present invention is not particularly limited as long as it has at least a transparent substrate film and a light reflecting layer 3, and a suitable layer configuration can be selected depending on each objective.

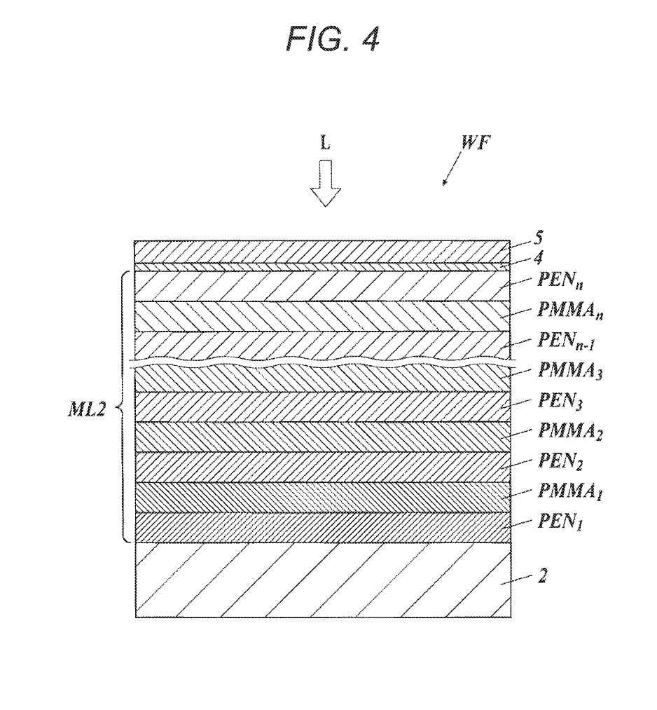

FIG. 3 and FIG. 4 are a cross-sectional view illustrating an exemplary configuration of the light reflecting film of the present invention which is provided with an infrared reflecting layer.

A preferred embodiment of the infrared reflecting layer is to have a configuration of FIG. 3 showing a laminate of a reflecting layer for reflecting selectively the light with specific wavelength in which a high refractive index reflecting layer containing a first water soluble binder resin and a first metal oxide particle and a low refractive index reflecting layer containing a second water soluble binder resin and a second metal oxide particle are alternately laminated.

The IR reflecting film WF shown in FIG. 3 has, as an infrared reflecting layer, a laminate ML1 having reflecting layer in which a high refractive index infrared reflecting layer containing a first water soluble binder resin and a first metal oxide particle and a low refractive index infrared reflecting layer containing a second water soluble binder resin and a second metal oxide particle are alternately laminated. The laminate ML1 having reflecting layer includes, from the substrate film 2 side, n layers including infrared reflecting layer T₁ to Tₙ, and, as an example, there is a constitution in which T₁, T₃, T₅, (omitted), Tₙ₋₂, Tₙ include a low reflective index layer of which refractive index is within a range of 1.10 to 1.60 and T₂, T₄, T₆, (omitted), Tₙ₋₁ include a high reflective index layer of which refractive index is within a range of 1.80 to 2.50. The refractive index described in the present invention indicates a value which is measured in an environment of 25° C.

FIG. 4 is a brief cross-sectional view illustrating an exemplary configuration of the IR reflecting layer which includes a laminate of polymer layer in an IR reflecting film.

The IR reflecting film WF shown in FIG. 4 is formed such that a laminate ML2 having a reflecting layer is formed by laminating on top of the substrate film 2 the two kinds of a polymer film having different material as an infrared reflecting layer. As an exemplary configuration, from the substrate film 2 side, PEN₁ formed of a polyethylene naphthalate film, PMMA₁ formed of a polymethylmethacrylate film, PEN₂, PMMA₂, PENS, PMMA₃, (omitted), PENₙ₋₁, PMMAₙ, and PENₙ are laminated to form the laminate ML2 having a reflecting layer. Total number of films to be laminated is preferably in a range of 150 to 1000 layers. With regard to the details of the laminate of polymer layer, a reference can be made to the descriptions of U.S. Pat. No. 6,049,419, for example.

If necessary, in the IR reflecting film of the present invention, various functional layers may be formed other than those layers described above.

Furthermore, according to the light reflecting film of the present invention, the buffer layer 4 and the self-restoring layer 5 according to the present invention are formed in order, either directly or via other functional layer, on top of Tₙ or PENₙ, which is the uppermost layer of ML1 or ML2.

<Substrate Film>

Examples of the substrate film which may be applied to the light reflecting body of the present invention include a transparent resin film. The term “transparent” described in the present invention indicates the average light transmittance of 50% or more, preferably 60% or more, more preferably 70% or more, and particularly preferably 80% or more in the visible light range.

Thickness of the substrate film is preferably in a range of 30 to 200 μm, more preferably in a range of 30 to 100 μm, and even more preferably in a range of 35 to 70 μm. If the thickness of the transparent resin film is 30 μm or more, it is unlikely to have an occurrence of wrinkles or the like during handling. On the other hand, if the thickness is 200 μm or less, the property of following a curved glass surface at the time of attaching on a glass substrate to produce laminated glass is improved, for example.

The transparent resin film is preferably a biaxially oriented polyester film. However, a nonstretched or a single-side stretched poly ester film can be also used. From the viewpoint of improving the strength and inhibiting thermal expansion, a stretched film is preferable. In particular, if laminated glass having the light reflecting film of the present invention is used as a front window of an automobile, a stretched film is more preferable.

From the viewpoint of preventing an occurrence of wrinkles in the light reflecting film or scratches in the infrared reflecting layer, the transparent resin film has thermal shrinkage rate in a range of 0.1 to 3.0% at the temperature of 150° C. It is more preferably in a range of 1.5 to 3.0%, and even more preferably 1.9 to 2.7%.

The transparent resin film which may be applied for the present invention is not particularly limited as long as it is transparent as described above. However, a polyolefin film (e.g., polyethlyene and polypropylene), a polyester film (e.g., polyethylene terephthalate and polyethylene naphthalate), a polyvinyl chloride, and a triacetyl cellulose film may be used. Preferably, it is a polyester film or a triacetyl cellulose film.

The polyester film (hereinbelow, simply referred to as polyester) is, although not particularly limited, a polyester having film forming property which has a dicarboxylic acid component and a diol component as a main constitutional component. Examples of the dicarboxylic acid component as a main constitutional component include terephthalic acid, isophthalic acid, phthalic acid, 2,6-naphthalene dicarboxylic acid, 2,7-naphthalene dicarboxylic acid, diphenylsulfone dicarboxylic acid, diphenyl ether dicarboxylic acid, diphenylethane dicarboxylic acid, cyclohexane dicarboxylic acid, diphenyl dicarboxylic acid, diphenyl thio ether dicarboxylic acid, diphenyl ketone dicarboxylic acid, and phenylindane dicarboxylic acid. Furthermore, examples of the diol component include ethylene glycol, propylene glycol, tetramethyleneglycol, cyclohexane dimethanol, 2,2-bis(4-hydroxyphenyl)propane, 2,2-bis(4-hydroxyethoxy phenyl)propane, bis(4-hydroxyphenyl)sulfone, bisphenol fluorine dihydroxyethyl ether, diethylene glycol, neopentylglycol, hydroquinone, and cyclohexane diol. Among the polyesters having those as a main constitutional component, from the viewpoint of the transparency, mechanical strength, and dimension stability, a polyester having terephthalic acid or 2,6-naphthalene dicarboxylic acid as a dicarboxylic acid component and ethylene glycol or 1,4-cyclohexane dimethanol as a diol component is preferable. In particular, a polyester having polyethylene terephthalate or polyethylene naphthalate as a main constitutional component, a copolymerization polyester including terephthalic acid, 2,6-naphthalene dicarboxylic acid, and ethylene glycol, and a polyester which contains a mixture of two or more kinds of those polyesters as a main component are preferable.

For having an easy handling property for a case in which a transparent resin film is used in the present invention, particles may be included within a range in which the transparency is not adversely affected. Examples of the particles which may be used for the transparent resin film include inorganic particles such as calcium carbonate, calcium phosphate, silica, kaolin, talc, titan dioxide, alumina, barium sulfate, calcium fluoride, lithium fluoride, zeolite or molybdenum sulfide and organic particles such as crosslinked polymer particles or calcium oxalate. Furthermore, as a method for adding the particles, an addition method in which the particles are included in polyester as a raw material, a method directly adding the particles to an extruder or the like can be mentioned. Any one of those methods may be used, or the two methods may be used in combination. According to the present invention, additives may be added other than the above particles, if necessary. Examples of the additives include a stabilizer, a lubricant, a crosslinking agent, an anti-blocking agent, an anti-oxidant, a dye, a pigment, and a UV absorbing agent.

The transparent resin film can be produced by a method which is conventionally known. For example, by melting a resin using an extruder and extruding it through a cyclic die or a T die followed by rapid cooling, a nonstretched transparent resin film which is substantially amorphous and not oriented can be produced. Furthermore, by stretching a nonstretched transparent resin film in a flow direction (i.e., longitudinal axis) of the transparent resin film or in a direction vertical to the flow direction (i.e., horizontal axis) of the transparent resin film by using a known method like monoaxial elongation, tenter type sequential biaxial elongation, tenter type simultaneous biaxial elongation, or a tubular type simultaneous biaxial elongation, a stretched transparent resin film can be produced. The elongation ratio in such case may be suitably selected based on the resins that are the raw material of the transparent resin film. However, it is preferably 2 to 10 times for the longitudinal axis direction and horizontal axis direction, respectively.

It is preferable that the transparent resin film is in-line coated, on a single surface or both surfaces, with a coating solution for undercoating layer during the film forming process. Examples of the resin used for the coating solution for undercoating layer, which is useful in the present invention, include a polyester resin, an acryl-modified polyester resin, a polyurethane resin, an acryl resin, a vinyl resin, a vinylidene chloride resin, a polyethylene imine vinylidene resin, a polyethylene imine resin, a polyvinyl alcohol resin, a modified polyvinyl alcohol resin, and gelatin, and all of them can be preferably used. The undercoating layer may be coated by a known method like roll coating, gravure coating, knife coating, dipping coating, and spray coating. The coating amount of the undercoating layer is preferably 0.01 to 2 g/m² (in dry state).

<Infrared Reflecting Layer>

Representative configuration of the infrared reflecting layer includes a laminate ML1 having a reflecting layer in which an infrared reflecting layer containing a water soluble binder resin and metal oxide particles is laminated in multilayer form as described with an aid of FIG. 3 and a laminate ML2 having a polymer layer as described with an aid of FIG. 4. In particular, an infrared reflecting layer which has different refractive index and has a water soluble binder resin and metal oxide particles is preferable.

<Laminate Having Reflecting Layer: ML1>

The laminate having a reflecting layer is sufficient to have at least one infrared reflecting layer. However, from the viewpoint of exhibiting an excellent heat shielding effect against sunlight and property of transmitting electromagnetic wave, the laminate having a reflecting layer as exemplified by FIG. 3 is a particularly preferred embodiment.

That is, it is a configuration to have a laminate having a reflecting layer in which the infrared reflecting layer with high refractive index (hereinbelow, also referred to as a high refractive index layer) containing a first water soluble binder resin and a first metal oxide particle and the infrared reflecting layer with low refractive index (hereinbelow, also referred to as a low refractive index layer) containing a second water soluble binder resin and a second metal oxide particle are alternately laminated.

With regard to the laminate having a reflecting layer, thickness per high refractive index layer is preferably in a range of 20 to 800 nm, and more preferably in a range of 50 to 350 nm. Furthermore, thickness per low refractive index layer is preferably in a range of 20 to 800 nm, and more preferably in a range of 50 to 350 nm.

Herein, when thickness per single layer is measured, the high refractive index layer and low refractive index layer may have a definite interface between them, or there may be a gradual change. For a case in which the interface is gradually changing, in a region in which respective layers are mixed to show a continuous change in refractive index, a point with “minimum refractive index between the two layers +Δn/2” is regarded as a layer interface when the maximum refractive index—the minimum refractive index is defined by Δn.

Concentration profile of the metal oxide in the laminate having a reflecting layer which is formed by alternate lamination of a high refractive index layer and a low refractive index layer can be measured based on atomic composition ratio, which is obtained by performing, in depth direction, an etching from a surface using a sputtering method and performing sputtering at rate of 0.5 nm/min using an XPS surface analyzer when the outermost surface is 0 nm. It is also possible to obtain the concentration profile by cutting the laminate having a reflecting layer and measuring the atomic composition ratio in the cut surface using an XPS surface analyzer. When the concentration of metal oxide is non-continuously changed in the mix region, the boundary may be confirmed based on a tomogram obtained by an electron microscope (TEM).

The XPS surface analyzer is not particularly limited, and any model can be used. However, ESCALAB-200R manufactured by VG Scientific can be used. Mg is used as an X ray anode and the measurement is performed at output power of 600 W (accelerating voltage of 15 kV and emission current of 40 mA).

With regard to the laminate having a reflecting layer, a preferred total layer number of the high refractive index layer and low refractive index is within a range of 6 to 100 layers, more preferably within a range of 8 to 40 layers, and even more preferably within a range of 9 to 30 layers.

With regard to the laminate having a reflecting layer, it is preferable to have a design such that the difference in refractive index between the high refractive index layer and low refractive index is as high as possible from the viewpoint of increasing the near IR reflectance with a low number of layers. Thus, the difference in refractive index between the adjacent high refractive index layer and low refractive index is preferably 0.1 or higher, more preferably 0.3 or higher, even more preferably 0.35 or higher, and particularly preferably 0.4 or higher. However, the uppermost layer or the lowermost layer may have a constitution which is different from the above preferred range.

With regard to the infrared reflecting layer, it is preferable that the lowermost layer adjacent to the transparent resin film is a low refractive index layer from the viewpoint of adhesiveness to the transparent resin film. Furthermore, the functional layer, for example, the uppermost layer adjacent to the buffer layer of the present invention, is also preferably a low refractive index layer which contains, as metal oxide particle, silicon dioxide in a range of 10 to 60% by mass.

Furthermore, the first and the second water soluble binder resins which are contained in the high refractive index layer or the low refractive index layer are preferably polyvinyl alcohol. Furthermore, it is preferable that the saponification degree of the polyvinyl alcohol contained in the high refractive index layer is different from the saponification degree of the polyvinyl alcohol contained in the low refractive index layer. Furthermore, it is preferable that the first metal oxide particle to be contained in the high refractive index layer is preferably a titan oxide particle, and also preferably a titan oxide particle of which surface is treated with hydrate oxide containing silicon.

[High Refractive Index Layer]

The high refractive index layer contains a first water soluble binder resin and a first metal oxide particle, and if necessary, it may contain a curing agent, other binder resins, a surface active agent, and various additives.

Refractive index of the high refractive index layer is preferably 1.80 to 2.50, and more preferably 1.90 to 2.20.

<First Water Soluble Binder Resin>

The first water soluble binder resin indicates a resin which shows an insoluble mass of 50% by mass or less of an added water soluble binder resin in which the insoluble is filtered and separated by a G2 glass filter (maximum pore diameter of 40 to 50 μm) after dissolving the water soluble binder in water to have concentration of 0.5% by mass at a temperature allowing maximum dissolution.

Weight average molecular weight of the first water soluble binder resin is preferably within a range of 1000 to 200000. It is more preferably within a range of 3000 to 40000.

The weight average molecular weight described in the present invention can be measured by a known method, and it can be measured by, for example, a gel permeation chromatography method (GPC), a time of flight mass analysis (TOF-MASS), or the like. In the present invention, the measurement is carried out by a gel permeation chromatography method as a conventionally known method.

Content of the first water soluble binder resin in the high refractive index layer is, relative to 100% by mass of the solid content of the high refractive index layer, preferably within a range of 5 to 50% by mass, and more preferably in a range of 10 to 40% by mass.

The first water soluble binder resin applied for the high refractive index layer is not particularly limited. However, the aforementioned hydrophilic polymer compound may be suitably adopted, and polyvinyl alcohol is particularly preferable. Furthermore, the water soluble binder resin which is present in the low refractive index layer described below is also preferably polyvinyl alcohol.

With regard to the high refractive index layer and the low refractive index layer, it is preferable to contain 2 or more kinds of polyvinyl alcohol, each having different saponification degree. Herein, for differentiation, the polyvinyl alcohol as a water soluble binder resin used for the high refractive index layer is described as the polyvinyl alcohol (A) and the polyvinyl alcohol as a water soluble binder resin used for the low refractive index layer is described as the polyvinyl alcohol (B). Furthermore, when each refractive index layer contains plural polyvinyl alcohols with different saponification degree or polymerization degree, the polyvinyl alcohol having the highest content in each refractive index layer is referred to as the polyvinyl alcohol (A) in the high refractive index layer and the polyvinyl alcohol (B) in the low refractive index layer, respectively.

The “saponification degree” described herein means a ratio of hydroxyl group relative to the total of acetyloxy group (i.e., derived from vinyl acetate as a raw material) and hydroxyl group in the polyvinyl alcohol.

The difference in absolute value of the saponification degree between the polyvinyl alcohol (A) and the polyvinyl alcohol (B) is preferably 3% by mol or higher, and more preferably 5% by mol or higher. When it is within this range, the interlayer mixing state between the high refractive index layer and the low refractive index layer is at a preferred level, and thus desirable. Furthermore, it is preferable that the difference in saponification degree between the polyvinyl alcohol (A) and the polyvinyl alcohol (B) is as high as possible. However, from the viewpoint of the solubility of polyvinyl alcohol in water, it is preferably 20% by mol or lower.

Furthermore, the saponification degree of the polyvinyl alcohol (A) and the polyvinyl alcohol (B) is, from the viewpoint of the solubility in water, preferably 75% by mol or higher.

Furthermore, with regard to the polymerization degree of 2 kinds of polyvinyl alcohol with different saponification degree, those with 1000 or higher are preferably used. In particular, those with the polymerization degree in a range of 1500 to 5000 are more preferable, and those with the polymerization degree in a range of 2000 to 5000 are also preferably used. That is because, when the polymerization degree of polyvinyl alcohol is 1000 or higher, no scratch occurs on a coating film. Furthermore, when it is 5000 or lower, a coating solution is stable.

The “polymerization degree (P)” described in the present application indicates viscosity average polymerization degree, and it is measured based on JIS K6726 (1994), and obtained from the intrinsic viscosity [η](cm³/g), which has been measured in water at 30° C., by the following formula after complete re-saponification of PVA and purification.

P=([η]×10³/8.29)^{(1/0.62)}

According to the present invention, it is preferable that 2 kinds of polyvinyl alcohol with different saponification degree are used for each layer with different refractive index.

For example, when the polyvinyl alcohol (A) with low saponification degree is used for the high refractive index layer and the polyvinyl alcohol (B) with high saponification degree is used for the low refractive index layer, it is preferable that the polyvinyl alcohol (A) in the high refractive index layer is contained preferably within a range of 40 to 100% by mass, and more preferably within a range of 60 to 95% by mass relative to the total mass of the whole polyvinyl alcohol in the layer, and the polyvinyl alcohol (B) in the low refractive index layer is contained preferably within a range of 40 to 100% by mass, and more preferably within a range of 60 to 95% by mass, relative to the total mass of the whole polyvinyl alcohol in the low refractive index layer. Furthermore, when the polyvinyl alcohol (A) with high saponification degree is used for the high refractive index layer and the polyvinyl alcohol (B) with low saponification degree is used for the low refractive index layer, it is preferable that the polyvinyl alcohol (A) in the high refractive index layer is contained preferably within a range of 40 to 100% by mass, and more preferably within a range of 60 to 95% by mass relative to the total mass of the whole polyvinyl alcohol in the layer, and the polyvinyl alcohol (B) in the low refractive index layer is contained preferably within a range of 40 to 100% by mass, and more preferably within a range of 60 to 95% by mass, relative to the total mass of the whole polyvinyl alcohol in the low refractive index layer. If the content is 40% by mass or more, interlayer mixing is suppressed so that the effect of lowering disturbances at an interface is significantly exhibited. On the other hand, if the content is 100% by mass or less, stability of the coating solution is improved.

As for the polyvinyl alcohol (A) and (B) used for the present invention, a synthetic product may be used or a commercially available product may be used. Examples of the commercially available product used as the polyvinyl alcohol (A) and (B) include PVA-102, PVA-103, PVA-105, PVA-110, PVA-117, PVA-120, PVA-124, PVA-203, PVA-205, PVA-210, PVA-217, PVA-220, PVA-224, PVA-235 (all manufactured by KURARAY CO., LTD), and JC-25, JC-33, JF-03, JF-04, JF-05, JP-03, JP-04, JP-05, JP-45 (all manufactured by JAPAN VAM & POVAL CO., LTD.).

<First Metal Oxide Particle>

As for the first metal oxide particle which can be applied to the high refractive index layer, a metal oxide particle having refractive index of 2.0 or higher and 3.0 or lower is preferable. Specific examples thereof include titan oxide, zirconium oxide, zinc oxide, synthetic non-crystalline silica, colloidal silica, alumina, colloidal alumina, lead titanate, red lead, yellow lead, zinc sulfide, chromium oxide, ferric oxide, black iron, copper oxide, magnesium oxide, magnesium hydroxide, strontium titanate, yttrium oxide, niobium oxide, europium oxide, lanthanum oxide, zircon, and tin oxide. Furthermore, a composite oxide particle including plural metals or a core•shell particle of which metal composition varies in core•shell form can be also used.

In order to form a high refractive index layer which is transparent and has higher refractive index, it is preferable to include, in the high refractive index layer, a microparticle of an oxide of metal with high refractive index like titan and zirconium, i.e., microparticle of titan oxide and/or microparticle of zirconia oxide. In particular, from the viewpoint of the stability of a coating solution for forming the high refractive index layer, titan oxide is more preferable. Furthermore, among titan oxides, the rutile type (tetragonal shape) is more preferable than the anatase type, since it has a lower catalytic activity so that the weather resistance of the high refractive index layer or an adjacent layer is enhanced and also the high refractive index is obtained.

Furthermore, in a case in which a core•shell particle is used as the first metal oxide particle in the high refractive index layer, from the viewpoint of the effect of suppressing interlayer mixing between the high refractive index layer and adjacent layer due to an interaction between hydrous oxide containing silicon in the shell layer and the first water soluble binder resin, a core•shell particle in which a particle of titan oxide is coated with hydrous oxide containing silicon is more preferable.

When content of the first metal oxide particle is within a range of 15 to 80% by mass relative to 100% by mass of the solid content of the high refractive index layer, it is preferable from the viewpoint of having a difference in refractive index compared to the low refractive index layer. Furthermore, it is more preferably within a range of 20 to 77% by mass, and even more preferably within a range of 30 to 75% by mass. Furthermore, when the metal oxide particle other than the above core•shell particle is contained in the high refractive index layer, the content is not particularly limited as long as the effect of the present invention can be obtained.

Volume average particle diameter of the first metal oxide particle which is applied for the high refractive index layer is preferably 30 nm or less, more preferably within a range of 1 to 30 nm, and even more preferably within a range of 5 to 15 nm. The volume average particle diameter within a range of 1 to 30 nm is preferable from the viewpoint of having little haze and excellent visible light transmittance.

The volume average particle diameter of the first metal oxide particle indicates an average particle diameter which is obtained by measuring particle diameter of 1000 arbitrary particles by a method for observing the particle itself with laser diffraction scattering method, dynamic scattering method, or a method of using an electron microscope, or by a method including observing the particle shape shown on a cross-section or a surface of the refractive index layer with an electron microscope, and, if the volume per particle is vi for a group of metal oxides with particle shape in which particles each having particle diameter of d1, d2 . . . di . . . dk are present in the number of n1, n2 . . . ni . . . nk, weighting the particle diameter by the volume as represented by the following: volume average particle diameter mv={Σ(vi·di)}/{Σ(vi)}.

<Curing Agent>

A curing agent may be used for curing the first water soluble binder resin which is applied for the high refractive index layer.

The curing agent which may be used with the first water soluble binder resin is not particularly limited as long as it may cause a curing reaction with the water soluble binder resin. For example, when polyvinyl alcohol is used as the first water soluble binder resin, boronic acid and a salt thereof are preferable.

Content of the curing agent in the high refractive index layer is preferably 1 to 10% by mass and more preferably 2 to 6% by mass relative to 100% by mass of the solid content of the high refractive index layer.

In particular, for a case in which polyvinyl alcohol is used as the first water soluble binder resin, the total use amount of the curing agent is preferably within a range of 1 to 600 mg per gram of the polyvinyl alcohol, and more preferably within a range of 100 to 600 mg per gram of the polyvinyl alcohol.

[Low Refractive Index Layer]

The low refractive index layer contains a second water soluble binder resin and a second metal oxide particle, and it may further contain a curing agent, a surface coating component, a particle surface protecting agent, a binder resin, a surface active agent, and various additives.

Refractive index of the low refractive index layer is preferably within a range of 1.10 to 1.60, and more preferably within a range of 1.30 to 1.50.

<Second Water Soluble Binder Resin>

As the second water soluble binder resin which is applied for the low refractive index layer, polyvinyl alcohol is preferably used. It is also more preferable that the polyvinyl alcohol (B) which has a saponification degree different from that of the polyvinyl alcohol (A) present in the high refractive index layer is used for the low refractive index layer. Furthermore, descriptions regarding the polyvinyl alcohol (A) and the polyvinyl alcohol (B) like preferred weight average molecular weight of the second water soluble binder resin have been already given in the descriptions of the water soluble binder resin for the high refractive index layer above, and thus further descriptions are omitted herein.

Content of the second water soluble binder resin in the low refractive index layer is, relative to 100% by mass of the solid content of the low refractive index layer, preferably within a range of 20 to 99.9% by mass, and more preferably in a range of 25 to 80% by mass.

<Second Metal Oxide Particle>

As for the second metal oxide particle which is applied for the low refractive index layer, it is preferable to use silica (silicon dioxide), and specific examples thereof include synthetic non-crystalline silica and colloidal silica. Among them, is it more preferable to use acidic colloidal silica sol. It is even more preferable to use colloidal silica sol dispersed in an organic solvent. To further lower the refractive index, as the second metal oxide particle which is applied for the low refractive index layer, it is possible to use hollow microparticles having voids inside the particle, and hollow microparticles of silica (silicon dioxide) are preferable.

The second metal oxide particle which is applied for the low refractive index layer (preferably, silicon dioxide) preferably has average particle diameter within a range of 3 to 100 nm. The average particle diameter of primary silicon dioxide particle dispersed in primary particle state (i.e., particle diameter in dispersion solution before coating) is more preferably within a range of 3 to 50 nm, even more preferably within a range of 3 to 40 nm, particularly more preferably within a range of 3 to 20 nm, and most preferably within a range of 4 to 10 nm. Furthermore, as for the average particle diameter of a secondary particle, 30 nm or less is preferable from the viewpoint of having less haze and excellent visible light transmittance.

<Curing Agent>

Similarly to the high refractive index layer, a curing agent may be also contained in the low refractive index layer of the present invention. In particular, when polyvinyl alcohol is used as the second water soluble binder resin which is applied for the low refractive index layer, boronic acid and a salt thereof and/or borax are preferable as a curing agent. In addition, well known ones other than boronic acid and a salt thereof can be also used.

Content of the curing agent in the low refractive index layer is preferably 1 to 10% by mass and more preferably 2 to 6% by mass relative to 100% by mass of the solid content of the low refractive index layer.

[Method for Forming Laminate Having Reflecting Layer]

As for the method for forming a laminate having a reflecting layer, it is preferable to carrying the forming by using a wet coating method. Furthermore, a production method including a step of wet coating a transparent substrate with a coating solution for high refractive index layer containing the first water soluble binder resin and the first metal oxide particle and a coating solution for low refractive index layer containing the second water soluble binder resin and the second metal oxide particle is preferable.

The wet coating method is not particularly limited, and examples thereof include a roll coating method, a rod bar coating method, an air knife coating method, a spray coating method, a sliding type curtain coating method, or a sliding hopper coating method and an extrusion coating method described in specifications of U.S. Pat. No. 2,761,419 and U.S. Pat. No. 2,761,791. Furthermore, the mode for multilayer coating of several layers may be a successive multilayer coating mode or a simultaneous multilayer coating mode.

<Polymer Laminate: ML2>

In a laminate of polymer layer as another example of the light reflecting body of the present invention, a plurality of a first polymer layer with a first refractive index and a second polymer layer with a second refractive index are laminated to form an infrared reflecting layer.

The first polymer layer and the second polymer layer are laminated on top of each other to form a laminate of polymer layer. Examples of the polymer material for forming the first and the second polymer layer include a blending or a copolymer of polyester, acryl, or polyester acryl, and examples thereof include polyethylene-2,6-naphthalate (PEN), naphthalene dicarboxylic copolyester (coPEN), polymethyl methacrylate (PMMA), polybutylene-2,6-naphthalate (PBN), polyethylene terephthalate (PET), naphthalene dicarboxylic acid derivative, diol copolymer, poly ether ketone, and a syndiotactic polystyrene resin (SPS). Specific examples of a combination of the first polymer layer and the second polymer layer include PEN/PMMA, PET/PMMA, PEN/coPEN, PEN/SPS, and PET/SPS.

As a specific example of the configuration of a laminate of polymer layer, two kinds of a polymer film, each having a different material, are laminated as described above with FIG. 4. Specifically, as shown in FIG. 4, from the bottom surface, PEN₁ formed of a polyethylene naphthalate film, PMM₁ formed of a polymethyl methacrylate film, PEN₂, PMMM₂, PENS, PMMA₃, (omitted), PENₙ₋₁, PMMAₙ, PENₙ are laminated to form the laminate ML2 of polymer layer.

It is preferable that the total number of the films to be laminated is, although not particularly limited, generally within a range of 150 to 1000 layers.

As to the details of the laminate of polymer layer, reference can be made to the descriptions given in the specification of U.S. Pat. No. 6,049,419.

[3.2] Film Mirror

As the light reflecting body according to the present invention, an outline of a film mirror for reflecting visible range light is described.

It is preferable for the film mirror as the light reflecting body of the present invention to have reflectance of preferably 50% or more, more preferably 70% or more, even more preferably 80% or more, and particularly preferably 90% or more in the light wavelength range of 450 to 650 nm, which is a visible light range. The reflectance of the film mirror is measured in a range of 450 to 650 nm by using a spectrophotometer (using integrating sphere, Model U-4000, manufactured by Hitachi High Technologies Corporation) in an environment of 23° C., 55% RH, and the mean reflectance is obtained and used as visible light reflectance.

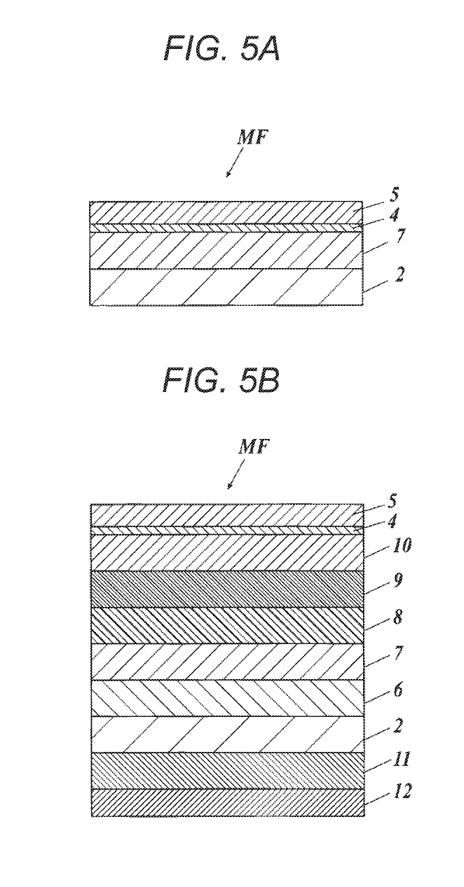

The minimum configuration of a film mirror MF includes a constitution in which, as shown in FIG. 5A, a metal reflecting layer (e.g., silver reflecting layer) 7 is formed on top of a substrate film 2 and the buffer layer 4 and the self-restoring layer 5 according to the present invention are formed on top of it.

It is preferable that various functional layers are indeed formed on the film mirror MF, and as shown in FIG. 5B, it is possible to form an anchor layer 6 between the substrate film 2 and the metal reflecting layer 7 and a resin coating layer 8 containing an anti-corrosion agent or an anti-oxidant is preferably formed on a light entrance side of the metal reflecting layer 7. It is also preferable that an adhesive layer 9 is formed on the resin coating layer 8, and according to a more preferred embodiment, an acryl resin layer 10 is formed on top of it.

Furthermore, on a surface opposite to the side on which a metal layer is provided on a substrate film, an adhesive layer 11 and a peeling sheet 12 are formed and attached to the substrate.

Total thickness of the film mirror is, from the viewpoint of preventing sagging of a mirror, and having specular reflectance and handling property, preferably in a range of 75 to 250 μm, more preferably in a range of 90 to 230 μm, and even more preferably in a range of 100 to 220 μm.

Hereinbelow, descriptions are given in order regarding each layer constituting the film mirror.

[Substrate Film]

It is preferable to use the transparent resin film which is used for the aforementioned IR reflecting film, and details are as described above.

In particular, a polycarbonate film, a polyester based film like polyethylene terephthalate, a norbornane based resin film, and a cellulose ester based film, and an acryl film are preferable. In particular, a polyester based film like polyethylene terephthalate or an acryl film is preferably used.

Thickness of the transparent resin film is preferably set to a suitable thickness depending on the type of a resin and objective or the like. It is generally in a range of 10 to 300 μm. Preferably, it is in a range of 20 to 200 μm, and more preferably in a range of 30 to 100 μm.

[Anchor Layer]

Anchor layer includes a resin and it allows close adhesion between the substrate film and metal reflecting layer. Resin material used for the anchor layer is not particularly limited, as long as it satisfies conditions of the strong adhesiveness, heat resistance, and smoothness. It is possible to use a polyester based resin, an acrylic resin, a melamine based resin, an epoxy based resin, polyamide based resin, a vinyl chloride based resin, or a vinyl chloride vinyl acetate copolymer based resin, either alone or as a mixture of those resins. From the viewpoint of the weather resistance, a mixture resin of a polyester based resin and a melamine based resin is preferable, and it is more preferable to have a thermosetting resin in which a curing agent like isocyanate is blended.

As a method for forming the anchor layer, a conventionally known coating method for applying and coating with a predetermined resin material like gravure coating method, reverse coating method, and die coating method can be used.

Thickness of the anchor layer is preferably in a range of 0.01 to 3 μm, and more preferably in a range of 0.1 to 1 μm.

[Metal Reflecting Layer]

The metal reflecting layer is a layer including metal or the like which has an activity of reflecting 50% or more of visible light (in a range of 450 to 650 nm).

Surface reflectance of the metal reflecting layer is preferably 80% or more, and more preferably 90% or more. The reflecting layer is preferably formed of a material which contains at least one element selected from a group of elements including Al, Ag, Cr, Cu, Ni, Ti, Mg, Rh, Pt and Au. In particular, from the viewpoint of the reflectance, it is preferable to contain aluminum (Al) or silver (Ag) as a main component, and it is also to possible to form two or more layers of such thin metal film.

According to the present invention, it is particularly preferable to use, as the metal reflecting layer, a silver reflecting layer containing silver as a main component (hereinbelow, the metal reflecting layer may be also referred to as a silver reflecting layer).

Thickness of the silver reflecting layer is preferably in a range of 10 to 200 nm, and more preferably in a range of 30 to 150 nm from the viewpoint of the reflectance or the like.

As a method for forming the reflecting layer, any one of a wet method and a dry method can be used. Representative examples of the wet method include a plating method, which is a method for forming a film by precipitating a metal from a solution. Specific examples thereof include a silver mirror method. Meanwhile, representative examples of the dry method include a vacuum film forming method, and specific examples thereof include a resistance heating type vacuum vapor deposition, an electron beam heating type vacuum vapor deposition, ion plating, ion beam assist vacuum vapor deposition, and sputtering method. In particular, in the present invention, a vapor deposition method allowing roll to roll mode for continuous film forming is preferably used. For example, a method for forming a silver reflecting layer by silver vapor deposition is preferably used for the method for producing a film mirror.

Furthermore, if thickness of the silver reflecting layer is set in a range of 30 to 300 nm as described above, it is possible to use a functional film having the silver reflecting layer as a film mirror. More preferably, the thickness is in a range of 80 to 200 nm from the viewpoint of durability. As the layer thickness of the silver reflecting layer is within the above range, it becomes possible to suppress a decrease in the reflectance in visible light range which is caused by light transmission or light scattering or the like resulting from generation of irregularities on a surface.

[Resin Coating Layer]

The resin coating layer is provided on a light entrance side of the silver reflecting layer, and it is preferably adjacent to the silver reflecting layer.

The resin coating layer contains a corrosion inhibitor or an anti-oxidant for silver, and it is also preferably provided with an activity of preventing corrosion or deterioration of the silver reflecting layer.

The resin coating layer may include a single layer only, or plural layers. Thickness of the resin coating layer is preferably in a range of 1 to 10 μm, and more preferably in a range of 2 to 8 μm.

As for the binder of the resin coating layer, the following resins can be preferably used, and examples thereof include polyester such as cellulose ester, polyester, polycarbonate, polyarylate, polysulfone (including also polyether sulfone) based, polyethylene terephthalate, or polyethylene naphthalate, polyethylene, polypropylene, cellophane, cellulose diacetate, cellulose triacetate, cellulose acetate propionate, cellulose acetate butyrate, polyvinylidene chloride, polyvinyl alcohol, ethylenevinyl alcohol, syndiotactic polystyrene based, polycarbonate, norbornane based, polymethylpentene, polyether ketone, polyether ketonimide, polyamide, a fluororesin, nylon, polymethylmethacrylate, and an acryl resin. Among them, from the viewpoint of the light resistance, the acryl resin with higher UV resistance is preferable.

The corrosion inhibitor preferably has a group which can adsorb silver. Herein, the term “corrosion” means a phenomenon having chemical or electrochemical erosion of a metal (silver) by a surrounding environmental material or deterioration of the material (see, JIS Z0103-2004).

Furthermore, it is preferable that the content of the corrosion inhibitor is generally in a range of 0.1 to 1.0 g/m² although the optimum amount may vary depending on the compound to be used.

As for the corrosion inhibitor having a group which can adsorb silver, it is preferably at least one of amines and a derivative thereof, a compound with a pyrrol ring, a compound with a triazole ring like benzotriazole, a compound with a pyrazole ring, a compound with a thiazole ring, a compound with an imidazole ring, a compound with an indazole ring, a copper chelate compound, a compound with a thiol group, thioureas, and naphthalenes, or it is selected from a mixture of them.

Regarding the compound like benzotriazole or the like, the UV absorbing agent may also function as a corrosion inhibitor. It is also possible to use a silicone modified resin. The silicone modified resin is not particularly limited.

As for those compounds, the compound described in paragraphs (0061) to (0073) of JP 2012-232538 A can be preferably used.

Examples of the commercially available product include LA31 manufactured by ADEKA CORPORATION and Tinuvin 234 manufactured by BASF Japan.

Furthermore, as an anti-oxidant which is a corrosion inhibitor having anti-oxidation property, a phenol based anti-oxidant, a thiol based anti-oxidant, or a phosphite based anti-oxidant is preferably used. Furthermore, as a photostabilizer, a hindered amine type photostabilizer or a nickel based UV stabilizer may be preferably used.

As for those compounds, the compound described in paragraphs (0046) to (0053) of JP 2012-232538 A can be preferably used.

Furthermore, it is preferable that the content of the anti-oxidant is generally in a range of 0.1 to 1.0 g/m² although the optimum amount may vary depending on the compound to be used.

[Adhesive Layer]

The adhesive layer is not particularly limited as long as it has an activity of enhancing the adhesiveness. Thickness of the adhesive layer is, from the viewpoint of the strong adhesiveness, smoothness, and reflectance of a reflecting material, preferably in a range of 0.01 to 10 μm, and more preferably in a range of 0.1 to 10 μm.

When the adhesive layer is a resin, the resin is not particularly limited as long as it satisfies the aforementioned strong adhesiveness and smoothness, and a polyester based resin, a urethane based resin, an acrylic resin, a melamine based resin, an epoxy based resin, a polyamide based resin, a vinyl chloride based resin, or a vinyl chloride vinyl acetate copolymer based resin may be used alone, or a mixture of those resins may be used. From the viewpoint of the weather resistance, a mixture resin of a polyester based resin and a melamine based resin is preferable, and it is more preferable to have a thermosetting resin in which a curing agent like isocyanate is blended. As for the method for forming the adhesive layer, a conventionally known coating method like gravure coating method, reverse coating method, and die coating method can be used.

For a case in which the adhesive layer is metal oxide, the adhesive layer may be formed according to film forming of silicon oxide, aluminum oxide, silicon nitride, aluminum nitride, lanthanum oxide, or lanthanum nitride based on various vacuum film forming methods. For example, the film forming can be carried out by a resistance heating type vacuum vapor deposition, an electron beam heating type vacuum vapor deposition, ion plating, ion beam assist vacuum vapor deposition, or a sputtering method.

[Acrylic Resin Layer]

The acrylic resin layer is preferably a layer containing a UV absorbing agent for the purpose of preventing deterioration of the film mirror caused by sunlight or UV rays. The acrylic resin layer is preferably provided more closely to the light entrance side than the resin substrate, and it is preferably provided more closely to the light entrance side than the metal reflecting layer.

Since the buffer layer according to the present invention has a UV absorbing property, it may be used also with the acrylic resin layer, and it is also preferable that a UV absorbing agent different from the buffer layer is contained in the acrylic resin layer.

The acrylic resin layer is a layer in which an acryl resin is used as a binder and thickness of the acrylic resin layer is preferably in a range of 1 to 200 μm.

As for the acrylic resin layer, SUMIPEX TECHNOLLOY S001G 75 μm. (manufactured by Sumitomo Chemical Co., Ltd.), which is a commercially available acryl film containing a UV absorbing agent, can be preferably used.

[3.3] Metal Gloss Film

It is also preferable to use a metal gloss film as the light reflecting body of the present invention.

The metal gloss film as the light reflecting body of the present invention has reflectance of preferably 50% or more, more preferably 70% or more, even more preferably 80% or more, and particularly preferably 90% or more in the light wavelength range of 450 to 650 nm as a visible light range.

The metal gloss film is not particularly limited. However, it is preferably a metal gloss film in which, for example, two pieces of polyester films are attached via an adhesive layer to form a substrate film, each of the two polyester films is a polyester film in which a layer having, as a main component, the polyester A including polyethylene terephthalate or polyethylene naphthalate and a layer having, as a main component, the polyester B containing cyclohexane dimethanol component in an amount of 25 to 35% by mol relative to the acid component are orderly laminated in thickness direction of the layer, and the film is obtained by using a substrate film with total layer number of 500 layers or more and 600 layers or less.

The layer having the polyester A as a main component and the layer having the polyester B as a main component preferably have an average planar refractive index difference of 0.03 or more. More preferably, it is 0.05 or more, and even more preferably 0.1 or more. When the refractive index layer is less than 0.03, sufficient reflectance may not be obtained in some cases.

It is important that, in the polyester film to be attached as a substrate film, a layer including the polyester A (i.e., layer A) and a layer including the polyester B (i.e., layer B) are alternately laminated to have 500 layers or more. When the number is 500 layers or more, it becomes possible to have reflectance of 70% or more in a target reflection range. By attaching each of two polyester films and setting the target reflection wavelength range to a region of 350 to 750 nm, a laminate film having an outer appearance with metal gloss can be obtained.

Furthermore, considering a decrease in wavelength selectivity in accordance with a decrease in lamination precision that is caused by having a large scale device or excessively large number of layers, the layer number is preferably 600 layers or less. The method for controlling the layer number to 500 layers to 600 layers can be achieved by modifying a feed block, and when the layer number is within a range of 500 layers to 600 layers, the IR transmittance and visible light reflectance can be balanced between the desired range of the present invention.

It is more preferable that the metal gloss film has average reflectance is within a range of 70 to 100% in wavelength of 350 to 750 nm.

It is also preferable that the average transmittance in wavelength of 900 to 1000 nm is within a range of 85 to 100%, and it is obtained by attaching two polyester films that are described below.

It is preferable that one of the polyester films to be attached has average reflectance of 70 to 100% in wavelength of 350 to 570 nm and average transmittance of 85 to 100% in wavelength of 620 to 1000 nm and the other has average reflectance of 70 to 100% in wavelength of 570 to 750 nm and average transmittance of 85 to 100% in wavelength of 350 to 550 nm and 900 to 1000 nm. By attaching those two polyester films, it is possible to achieve simultaneously the average reflectance of 70 to 100% in wavelength of 350 to 750 nm and average transmittance of 85 to 100% in wavelength of 900 to 1000 nm.

Furthermore, thickness of the metal gloss film is preferably in a range of 100 to 300 μm from the viewpoint of the handling property. To prevent wrinkles during molding, enhancing the handling property, and preventing wash out of a decorative film, it is preferably 100 μm or more. When the thickness of 300 μm or less, curl is not strong, setting a sheet on a molding device frame is not cumbersome, and the productivity is high.

In the metal gloss film, the buffer layer and self-restoring layer according to the present invention are formed on a surface of the polyester film having the constitution described above, and it can prevent cracks of a cured film which is caused by surface hardness, stress by bending or the like.

Furthermore, the metal gloss film may have, in addition to the buffer layer and self-restoring layer according to the present invention, a functional layer like a hard coat layer, an anti-static layer, an abrasion resistance layer, an anti-reflection layer, a color calibration layer, a UV absorbing layer, a print layer, a transparent electroconductive layer, a gas barrier layer, a hologram layer, a peeling layer, a sticky layer, an emboss layer, an adhesive layer, and a release layer suitably formed thereon.

A preferred method for producing the metal gloss film is described hereinbelow.

First, the method for producing a polyester film in which a layer containing the polyester A as a main component and a layer containing the polyester B as a main component, which are used for the metal gloss film, are laminated in number of 500 layers or more (hereinbelow, described as a laminate film) is described.

Two kinds of the polyester A and the polyester B are prepared in pellet form or the like. If necessary, the pellets are subjected to preliminary drying in hot air or vacuum state, and then supplied to an extruder. The resins heated and melt at temperature of more than the melting point within an extruder are extruded with an even extrusion amount using a gear pump or the like, and via a filter or the like, impurities or deteriorated resins or the like are removed.

The polyester A and the polyester B transported from different flow path by using those 2 or more extruders are transported next to a device for multilayer lamination. As a device for multilayer lamination, a multi manifold die, a feed block, or a static mixer can be used. It is also possible to use them in any combination. In particular, a multi manifold die or a feed block allowing separate control of thickness of each layer is preferable. Furthermore, to have fine control of the thickness of each layer, a feed block provided with a fine slit for controlling flow amount in each layer based on electric discharge processing or wire electric discharge processing with precision of 0.1 mm or less is preferable. Furthermore, to reduce the non-uniformity in resin temperature at that time, heating based on circulation of a heating medium is preferable. Furthermore, to suppress a wall surface resistance in a feed block, the roughness of a wall surface can be set at 0.4 S or less, or the contact angle with water can be 30° or higher at room temperature.

To obtain a polyester film which is used for the metal gloss film of the present invention, it is important to have an optimum lamination configuration depending on spectrophotometric properties of a metal gloss film to be designed. However, it is particularly preferable that preparation of the substrate is carried out by film forming using a feed block, which has microslits corresponding to each wavelength range.

The melt laminate formed to have a desired layer configuration is molded to a desired shape by a next die, and then discharged. The multilayer-laminated sheet which has been discharged from a die is pushed to a cooling body like casting drum or the like for cooling and solidification to yield a casting film. In this case, a method for rapid solidification by closely adhering on a cooling body like casting drum based on an electrostatic force which uses an electrode having wire shape, tape shape, needle shape, or knife shape, a method for rapid solidification by closely adhering on a cooling body like casting drum after discharging air from a device with slit shape, spot shape, or plane shape, or a method for rapid solidification by closely adhering on a cooling body using nip roll is preferable.

The casting film obtained as above is preferably subjected to biaxial elongation, if necessary. The biaxial elongation indicates elongation both in length direction and width direction. The elongation may be sequential biaxial elongation or simultaneous elongation in two directions.

Next, attachment of two pieces of a polyester film is carried out via an adhesive. When the attachment is made via an adhesive, a progress of crystallization of the polyester B, which is caused by heating, can be prevented and the reflection wavelength range can be exhibited as designed compared to heat fusion or the like.

With regard to the method for producing the metal gloss film, mass of the adhesive layer, which is formed on a single surface of the polyester film, per unit area is preferably about 1 to 30 g/m². By having this mass per unit area, an adhesive layer with thickness of 1 to 30 μm is obtained. When it is less than 1 g/m², adhesiveness becomes weaker to easily yield peeling. On the other hand, when it is more than 30 g/m², dryness may be lowered and a poor outer appearance may be yielded. In addition, as it easily yields a pressed mark of impurities or leads to a deterioration in design property, and thus it is undesirable.

As a coating method for forming a curing type adhesive layer, a coating method using a gravure coater, a gravure reverse coater, a lip coater, a flexo coater, a blanket coater, a roll coater, a knife coater, an air knife coater, a kiss touch coater, a kiss touch reverse coater, a coating coater, a comma reverse coater, a micro reverse coater, or the like can be used.

According to the adhesion step, an adhesive is applied on a single surface of the polyester film and other polyester film is attached using a laminate nip roller. At that time, it is preferable to carry out a heating treatment at 40 to 120° C. after applying the adhesive on a single surface of the polyester film. It is preferable that the second polyester is roll-laminated on a laminate nip roller heated to 40 to 120° C. under nip pressure of 0.2 to 1.0 MPa.

In a conveying zone till to winding after attachment, a plurality of conveying rollers are generally used due to a device for detecting defects and/or a device for controlling tension or absorbing loosening of a sheet during change of a winding roller, and to inhibit any staggering of a sheet in width direction, the sheet is conveyed at suitable contact angle on each conveying roller.

After passing through a plurality of conveying rollers, the obtained laminate film in roll-wound state is subjected to a heating treatment at 20 to 60° C. for 24 to 168 hours for the purpose of winding on a sheet winding core and curing of the adhesive. If the temperature for the heating treatment is 20° C. or higher and the time for the heating treatment is 24 hours or longer, curing of the adhesive is sufficient so that sufficient adhesion strength is obtained and a staggering or the like of the film attached in the following steps does not occur. Furthermore, if it is 60° C. or lower and the time for the heating treatment is 168 hours or shorter, there is no squeeze mark on a sheet prepared in roll shape and the sheet becomes suitable for a decorative application.

[4] Decorative Molding Method and Use of Light Reflecting Film

[4.1] Decorative Molding Method

According to the light reflecting film of the present invention, it is preferable that a sticky layer or an adhesive layer is formed on a surface opposite to the self-restoring layer of the light reflecting film and a decorative molding for attaching the light reflecting film on a substrate via the sticky layer or adhesive layer under thermal molding at a temperature of 80° C. or higher is performed.

The substrate described herein indicates a plastic material (main body) which preferably allows obtainment of a curved surface body.

According to the decorative molding by which the light reflecting film of the present invention is attached on a substrate by thermal molding at a temperature of 80° C. or higher, an uncured monomer in the buffer layer is crosslinked and polymerized. In addition, as the content of the uncured monomer is 3% by mass or less, strength of the buffer layer itself is enhanced so that the scratch resistance of the self-restoring layer can be improved.

Preferred temperature is within a range of 80 to 200° C., more preferably within a range of 80 to 150° C., and particularly preferably within a range of 80 to 120° C.

[Sticky Layer]

The sticky layer is a constitutional layer to attach and fix the light reflecting film of the present invention to a substrate.

The sticky layer is not particularly limited as long as it allows adhesion of the light reflecting film on a substrate. For example, a dry laminate agent, a wet laminate agent, a sticky agent, a heat sealing agent, a hot melt agent or the like can be used. It is also possible to use a polyester based resin, a urethane based resin, a polyvinyl acetate based resin, an acrylic resin, nitrile rubber or the like.

The lamination method for applying the sticky layer on a back surface of a substrate film is not particularly limited, and a continuous roll type method is preferred from the viewpoint of economic efficiency and productivity.

It is preferable that thickness of the sticky layer is generally in a range of 1 to 50 wn or so from the viewpoint of adhesion effect, drying speed, or the like.

As for specific materials used for the sticky layer, a sticky agent like “SK Dyne series” manufactured by Soken Chemical & Engineering Co., Ltd., Oribain BPW series and BPS series manufactured by TOYO INK CO., LTD., and “Arkon”, “Super Ester”, and “Hyper” manufactured by Arakawa Chemical Industries, Ltd. can be suitably used.

It is also preferable that the sticky layer is covered with a release sheet until the adhesion of the film mirror on a substrate so that the stickiness of the sticky layer can be maintained.

It is also preferable to contain in the sticky layer at least one of amines and a derivative thereof, a compound with a pyrrol ring, a compound with a triazole ring like benzotriazole, a compound with a pyrazole ring, a compound with a thiazole ring, a compound with an imidazole ring, a compound with an indazole ring, a copper chelate compound, a compound with a mercapto group, thioureas, and naphthalenes, or a mixture of them.

[Adhesive Layer]

The adhesive layer of the present invention is not particularly limited, but it is preferably an adhesive including a urethane based resin. The adhesive including a urethane based resin works as an adhesive as it is cured by combining and reacting polyol having a hydroxyl group at the end with polyisocyanate, or a urethane prepolymer having an isocyanate group at the end with polyol.

As for the polyol, poly ether polyol, polyester polyol, and other polyol may be used. Examples of the polyether polyol include polyoxyethylene polyol, polyoxypropylene polyol, polyoxyethylene-propylene copolymerization polyol, and polytetramethylene polyol, either alone or as a mixture of them. Examples of the polyester polyol include polyol which is obtained by condensation polymerization of dicarboxylic acid (adipic acid, succinic acid, maleic acid, phthalic acid, or the like) with glycol (ethylene glycol, propylene glycol, 1,4-butylene glycol, 1,6-hexane glycol, neopentylglycol or the like) such as polyethlyene adipate, polybutylene adipate, polyhexamethylene adipate, polypropylene adipate, or polyethylene-propylene adipate, and polylactone polyol like polycaprolactone polyol, either alone or as a mixture of them, and polycarbonate polyol.

Examples of the polyisocyanate include aromatic polyisocyanate such as 2,4-tolylene diisocyanate, xylene diisocyanate, 2,6-tolylene diisocyanate, 4,4-diphenylmethane diisocyanate, polymethylene polyphenylene polyisocyanate, carbodiimide modified MDI, or naphthalene diisocyanate, hexamethylene diisocyanate, isophorone diisocyanate, 4,4-dicyclohexylmethane diisocyanate and alicyclic polyisocyanate. The polyisocyanate can be used either singly or as a mixture of them.

Furthermore, the adhesive layer used in the present invention may be blended with various additives such as a viscosity controlling agent, a leveling agent, an anti-gelling agent, an anti-oxidant, a heat-resistant stabilizer, a light-resistance stabilizer, a UV absorbing agent, a gliding agent, a pigment, a due, an organic or inorganic microparticle, a filler, an anti-static agent, or a nucleating agent.

[4.2] Laminated Glass

The laminated glass of the present invention is preferably produced by sandwiching the IR reflecting film as the light reflecting film of the present invention with 2 pieces of a member for constituting glass.

That is, in the laminated glass of the present invention, from the light entrance side, a member for constituting glass on one side, IR reflecting film WF and a glass substrate on the other side are arranged in order. Furthermore, 2 pieces of a glass substrate may be a glass substrate of the same type or a glass substrate of different type.

The member for constituting the laminated glass may be a member for constituting the laminated glass with plane shape or a member for constituting glass with curved surface shape like those used for a front window of an automobile. In particular, the IR reflecting film having the buffer layer and self-restoring layer of the present invention is excellent in terms of application to a member for constituting glass with a curved surface shape.

In a case in which the member for constituting the laminated glass according to the present invention is used as window glass of an automobile, it is preferable to have visible light transmittance of 70% or more. Furthermore, the visible light transmittance can be measured based on JIS R3106 (1998) “Testing method on transmittance and reflectance of flat glasses and evaluation of solar heat gain coefficient” by using a spectrophotometer (U-4000 manufactured by Hitachi High Technologies Corporation).

[Member for Constituting Glass]

Examples of the laminated glass include inorganic glass (hereinbelow, also simply described as glass) and organic glass (resin grazing). Examples of the inorganic glass include float plate glass, heat absorbing plate glass, polished plate glass, frame plate glass, wire plate glass, line plate glass, and colored glass like green glass. The organic glass is a synthetic resin glass which is used as a substitute of an inorganic glass. Examples of the organic glass (resin grazing) include a polycarbonate plate and poly (meth)acrylate plate. Examples of the poly (meth)acrylate plate include a polymethyl (meth)acrylate plate. In the present invention, inorganic glass is preferable from the viewpoint of having stability at the time of breakage caused by increased impact from an outside.

Type of the inorganic glass is not particularly limited, but soda lime silica glass is suitably used in general. In that case, it may be colorless transparent glass or colored transparent glass.

Between the two types of a glass substrate, the glass substrate on outdoor side which is close to incident light is preferably a colorless transparent glass. Furthermore, the glass substrate on indoor side which is distant from incident light is preferably a green colored transparent glass or strongly colored transparent glass. As for the green colored transparent glass, glass with UV absorbing property and IR absorbing property is preferable. That is because, by using them, sun light energy can be possibly reflected on an outdoor side and sun light transmittance of the laminated glass can be reduced.

Examples of the green colored transparent glass include, although not particularly limited, soda lime silica glass containing iron. For example, it is soda lime silica glass which contains, in raw material glass of soda lime silica, 0.3 to 1% by mass of total iron in terms of Fe₂O₃. Furthermore, since absorption of light having wavelength in near IR region is dominated by divalent iron in the entire iron, in terms of Fe₂O₃, mass of FeO (i.e., divalent iron) is 20 to 40% by mass of total iron.

In order to give a UV absorbing property, there is a method of adding cerium or the like to raw material glass of soda lime silica. Specifically, it is preferable to use soda lime silica glass which substantially has the following composition —SiO₂: 65 to 75% by mass, Al₂O₃: 0.1 to 5% by mass, Na₂O+K₂O:10 to 18% by mass, CaO: 5 to 15% by mass, MgO: 1 to 6% by mass, total iron in terms of Fe₂O₃: 0.3 to 1% by mass, total cerium in terms of CeO₂ and/or TiO₂: 0.5 to 2% by mass.

Furthermore, examples of the strongly colored transparent glass include, although not particularly limited, soda lime silica glass containing iron at high concentration.

For using the laminated glass of the present invention as window glass of an automobile or the like, thickness of a glass substrate on indoor side and a glass substrate on outdoor side is all 1.5 to 3.0 mm. In that case, both the glass substrate on indoor side and glass substrate on outdoor side can have the same thickness or different thickness. When the laminated glass is used as window glass of an automobile, both the glass substrate on indoor side and glass substrate on outdoor side can have a thickness of 2.0 mm or a thickness of 2.1 mm. Furthermore, when the laminated glass is used as window glass of an automobile, by having the glass substrate on indoor side to have a thickness of less than 2 mm and the glass substrate on outdoor side to have a thickness of 2 mm or more, the whole thickness of the glass substrate can be reduced while resistance to external force from the outside of an automobile is obtained. The glass substrate on indoor side and glass substrate on outdoor side may have a flat plate shape or a curved shape. Since a window of a vehicle, in particular, an automobile, often has a curved shape, the glass substrate on indoor side and glass substrate on outdoor side have a curved shape in many cases. In that case, a laminate of infrared reflecting layer is provided on a concave surface of the glass substrate on outdoor side. Furthermore, it is also possible to use 3 or more kinds of a glass substrate, if necessary.

Method for producing the laminated glass of the present invention is not particularly limited. For example, the IR reflecting film of the present invention is sandwiched between the member for constituting the laminated glass G1 and G2 followed by passing through a pressurized roll (also referred to as nip roll), or after adding it in a rubber bag and suctioning under reduced pressure, air remained in a space between the IR reflecting film of the present invention and the member for constituting the laminated glass G1 and G2 is removed. After that, according to preliminary adhesion at 70 to 110° C. approximately, a laminate is obtained. Then, the laminate is added to an autoclave or pressed to press it at pressure of 1 to 1.5 MPa at 120 to 150° C. approximately. Accordingly, laminated glass can be obtained.

The laminated glass may be used for an automobile, a train, an airplane, a ship, a building or the like. The laminated glass can be also used for the applications other than those. The laminated glass is preferably laminated glass for a building or a vehicle. The laminated glass can be used as front window, side window, rear window, or roof window of an automobile.

[4.3] Curved Surface Body

The light reflecting film of the present invention can be suitably used for decoration of a surface of plastic body which is used for home appliances, OA instruments, cellular phones, or interior decoration of automobiles.

In particular, according to the following molding method, a curved surface body with high design property like addition of metal gloss or complex patterns can be formed on a member of which shape is a curved surface shape.

Since the light reflecting film of the present invention is provided with the buffer layer and self-restoring layer of the present invention, it has a characteristic property that a scratch is unlikely to occur on a curved surface body and the light resistance is high.

As for the molding method, a method of in-mold molding a resin used for the substrate and the light reflecting film of the present invention by injection molding is mainly carried out. However, a vacuum•compression method (i.e., overlay method) by which attachment and transfer on a molded article is carried out later can be also used. Furthermore, the in-mold molding is categorized into in-mold lamination and in-mold transfer, and suitable selection can be made between them.

### EXAMPLES

Hereinbelow, the present invention is specifically described with reference to the examples but the present invention is not limited to them. Furthermore, the description of “parts” or “%” is described in the examples, and it indicates “parts by mass” or “% by mass”, unless specifically described otherwise.

### Example 1

### <<Light Reflecting Body: Production of IR Reflecting Film>>

### [Light Reflecting Body 1: Production of the IR Reflecting Film 1]

As a transparent substrate film, a polyethylene terephthalate film with thickness of 50 μm (Cosmo Shine A4300, manufactured by TOYOBO CO., LTD., both surfaces with easy-adhesion treatment, abbreviation: PET) was used.

Subsequently, as a light reflecting layer, the IR reflecting film 1 in which a high refractive index layer containing the first water soluble binder resin and the first metal oxide particle and a low refractive index layer containing the second water soluble binder resin and the second metal oxide particle are alternately laminated was produced as shown below (corresponding to FIG. 3).

(1) Forming of Undercoating Layer

A coating solution for an undercoating layer was applied on a transparent substrate film so as to have coating of 15 ml/m² using an extrusion coater. Then, after passing through a windless zone (1 second) at 50° C., it was dried for 30 seconds at 120° C. to obtain a support attached with an undercoating layer.

<Preparation of Coating Solution for Undercoating Layer>

| | | |
|---|---|---|
| Deionized gelatin | 10 | g |
| Pure water | 30 | ml |
| Acetic acid | 20 | g |
| Following cross-linking agent | 0.2 | mol/g of gelatin |
| Following fluorine-containing | 0.2 | g |
| nonionic surface active agent | | |

By adjusting it to 1000 ml using an organic solvent of methanol/acetone=2/8, a coating solution for an undercoating layer was prepared.

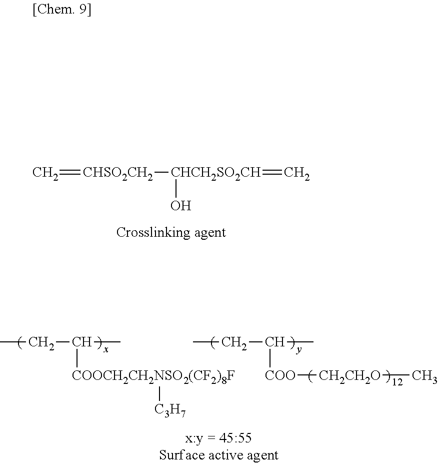

<Preparation of Deionized Gelatin>

After performing a lime treatment, washing and a neutralization treatment, ossein from which lime has been removed was subjected to an extraction treatment in hot water at 55 to 60° C. to obtain ossein gelatin. The obtained aqueous solution of ossein gelatin was subjected to an amphoteric ion exchange on a mixture bed of an anionic exchange resin (Diaion PA-31G) and a cationic exchange resin (Diaion PK-218).

(2) Forming of Infrared Reflecting Layer

By using a sliding hopper coater (i.e., slide coater) which allows multilayer coating, the coating solution L1 for low refractive index layer and the coating solution H1 for high refractive index layer were applied, while being maintained at 45° C., on a support which has been coated with the above undercoating layer and heated to 45° C. such that thickness of each of the low refractive index layer and the high refractive index layer is 130 nm after drying and the low refractive index layer is provided as the lowermost layer and the uppermost layer, i.e., simultaneous multilayer coating of total 18 layers including 10 layers of the low refractive index layer and 8 layers of the high refractive index layer that are present in alternate manner was performed.

Right after the application, cold wind at 5° C. was sprayed for 5 minutes for setting. After that, hot wind at 80° C. was sprayed for drying to form an infrared reflecting layer including 18 layers.

[Preparation of Coating Solution L1 for Low Refractive Index Layer]

First, 680 parts of an aqueous solution of colloidal silica (SnowTex (registered trademark) OXS manufactured by Nissan Chemical Industries, Ltd.) as 10% by mass second metal oxide particle, 30 parts of an aqueous solution of 4.0% by mass polyvinyl alcohol (PVA-103 manufactured by KURARAY CO., LTD: polymerization degree of 300, and saponification degree of 98.5% by mol), and 150 parts of a 3.0% by mass aqueous solution of boronic acid were admixed with one another and dispersed. After adding purified water, the colloidal silica dispersion L1 in an amount of 1000 parts in total was prepared.

Subsequently, the obtained colloidal silica dispersion L1 was heated to 45° C., and 760 parts of an aqueous solution of 4.0% by mass of the polyvinyl alcohol (B) (JP-45 manufactured by JAPAN VAM & POVAL CO., LTD.: polymerization degree of 4500, and saponification degree of 86.5 to 89.5% by mol) were added in order thereto under stirring. After that, 40 parts of an aqueous solution of 1% by mass betaine surface active agent (Softazoline (registered trademark) LSB-R manufactured by Kawaken Fine Chemicals CO., LTD.) were added to prepare the coating solution L1 for low refractive index layer.

[Preparation of Coating Solution H1 for High Refractive Index Layer]

(Preparation of Rutile Type Titan Oxide as Core of Core•Shell Particle)

By suspending titan oxide hydrate in water to have concentration of 100 g/L in terms of TiO₂, an aqueous suspension of titan oxide was prepared. To the suspension of 10 liters, 30 liters of an aqueous solution of sodium hydroxide (concentration: 10 mol/L) were added under stirring followed by heating to 90° C. and aging for 5 hours. Subsequently, neutralization using hydrochloric acid was performed, and after filtering, washing with water was performed. Furthermore, for the above reaction (treatment), the titan oxide hydrate as a raw material is obtained by thermal hydrolysis of an aqueous solution of titan sulfate according to a known method.

After suspending the above titan compound treated with base in water to have concentration of 20 g/L in terms of TiO₂, citric acid was added under stirring in an amount of 0.4% by mol compared to the amount of TiO₂. After heating, when the temperature of the mixed sol solution is 95° C., conc. hydrochloric acid was added to have hydrochloric acid of 30 g/L. It was stirred for 3 hours while maintaining the liquid temperature at 95° C. to prepare a sol solution of titan oxide.

As a result of measuring pH and zeta potential of the sol solution of titan oxide obtained from above, pH was found to be 1.4 and zeta potential was found to be +40 mV. Furthermore, the particle size measurement was carried out by using Zetasizer Nano manufactured by Malvern Instruments Ltd., and the monodispersity was found to be 16%.

Furthermore, the sol solution of titan oxide was dried for 3 hours at 105° C. to obtain powder microparticles of titan oxide. By using JDX-3530 manufactured by JEOL Datum Ltd., the powder microparticles were measured by X ray diffraction measurement. As a result, they were confirmed to be microparticles of titan oxide of rutile type. Furthermore, the volume average particle diameter of the microparticles was 10 nm.

To 4 kg of pure water, a 20.0% by mass aqueous dispersion of titan oxide sol containing the obtained microparticles of titan oxide of rutile type, which have volume average particle diameter of 10 nm, was added to obtain a sol solution to become core particles.

(Preparation of Core•Shell Particle by Shell Coating)

To 2 kg of pure water, 0.5 kg of a 10.0% by mass aqueous dispersion of titan oxide sol was added followed by heating to 90° C. Thereafter, 1.3 kg of an aqueous solution of silicate which has been prepared to have concentration of 2.0% by mass in terms of SiO₂ was slowly added and subjected to a heating treatment for 18 hours in an autoclave at 175° C. followed by concentration. Accordingly, a sol solution of core•shell particle (average particle diameter: 10 nm) which has titan oxide with rutile type structure as a core particle and SiO₂ as a coating layer was obtained (solid matter concentration: 20% by mass).

[Preparation of Coating Solution H1 for High Refractive Index Layer]

28.9 parts of the sol solution containing core•shell particle as the first metal oxide particle with solid matter concentration of 20.0% by mass obtained as above, 10.5 parts of a 1.92% by mass aqueous solution of citric acid solution, 2.0 parts of 10% by mass polyvinyl alcohol (PVA-103 manufactured by KURARAY CO., LTD: polymerization degree of 300, and saponification degree of 98.5% by mol), and 9.0 parts of a 3% by mass aqueous solution of boronic acid were admixed with one another and dispersed to prepare core•shell particle dispersion HE

Subsequently, the obtained core•shell particle dispersion H1 was stirred and 16.3 parts of pure water, and 33.5 parts of an aqueous solution of 5.0% by mass of the polyvinyl alcohol (A) (PVA-124 manufactured KURARAY CO., LTD.: polymerization degree of 2400, and saponification degree of 98 to 99% by mol) were added thereto. After that, 0.5 part of an aqueous solution of 1% by mass betaine surface active agent (Softazoline (registered trademark) LSB-R manufactured by Kawaken Fine Chemicals CO., LTD.) was added thereto. By using pure water, the coating solution H1 for high refractive index layer was obtained in an amount of 1000 parts in total.

[Light Reflecting Body 2: Production of IR Reflecting Film 2]

With reference to the examples of JP 2008-528313 A, an IR reflecting multilayer film which has about 446 layers on a polyethylene terephthalate with thickness of 6 μm as a transparent substrate film was produced by co-extrusion method (corresponding to FIG. 4).

The IR reflecting film 2 including multilayer polymer was produced with coPEN and PETG ((PET copolymerization, copolyester: product of Eastman Chemicals). The coPEN was polymerized by using starting monomers having 90% PEN and 10% PET. By using a feed block method (described in the specification of U.S. Pat. No. 3,801,429), an optical layer having about 446 layers in which almost linear gradient in thickness direction is present from layer to layer of an extrudate was formed.

Thickness of each layer was 6 μm for the transparent resin film, and including an IR reflecting multilayer film layer, the whole layer thickness was 36 μm.

<<Production of Light Reflecting Film>>

### <Production of Light Reflecting Film 101>

On top of a light reflecting layer of the IR reflecting film 1 which has been produced above, a buffer layer and a self-restoring layer were formed according to the following steps to produce the light reflecting film 101.

(1) Forming of Buffer Layer

<Acryl Polymer Polymerized from Monomer Composition Containing UV Stable Monomer and UV Absorbing Monomer>

To a 1 liter flask equipped with a stirrer, a dropping inlet, a thermometer, a condenser, and an inlet for nitrogen gas, 200 parts by butyl acetate were added, nitrogen gas was added, and the mixture was heated to 90° C. under stirring. A mixture containing 45 parts of 4-methacryloyloxy-2,2,6,6-tetramethyl piperidine as a UV stable monomer, 90 parts of glycidyl methacrylate, 165 parts of butyl methacrylate, and 1.5 parts of 2,2′-azobis(2-methyl butyronitrile) as an initiator was added dropwise to the prepared product over 4 hours. After the dropwise addition, it was further heated for 2 hours. Next, under flushing with mixture gas of nitrogen and oxygen, the temperature was raised to 110° C., and a mixture containing 51 parts of acrylic acid, 0.51 part of tetraphenyl phosphonium bromide as an esterification catalyst, and 0.05 part of methoquinone as a polymerization inhibitor was added dropwise thereto over 30 minutes. By allowing the reaction to occur for additional 6 hours after the dropwise addition, 65% solution of acryl monomer having acryloyl group in a side chain was obtained. The acid number of the obtained solution was 15 mgKOH and the number average molecular weight was 14300.

<Forming of Buffer Layer>

The above acryl polymer solution was applied on top of the infrared reflecting layer of the IR reflecting film 1 so as to have dry layer thickness of 5 μm. According to drying for 0.25 minute at 80° C., a buffer layer was formed.

(2) Forming of Self-Restoring Layer

Subsequently, on top of the formed buffer layer, the following self-restoring layer composition 1, which has been filtered through a polypropylene filter with pore diameter of 0.4 μm, was continuously applied using microgravure coater without performing an aging treatment. After drying with constant rate drying temperature of 80° C. and falling rate drying temperature of 80° C., the coating layer was cured with luminance of 100 mW/cm² in an illumination part and illumination amount of 0.3 J/cm² (300 mJ/cm²) using a UV lamp while performing nitrogen purging to have an atmosphere in which oxygen concentration is 1.0% by volume or less. Accordingly, a self-restoring layer with dry layer thickness of 20 μm was formed. After winding, the light reflecting film 101 in roll shape was produced.

[Self-restoring layer composition 1]

| | |
|---|---|
| AUP-787 (manufactured by Tokushiki Co., Ltd.) | 100 parts by mass |
| Methyl ethyl ketone | 50 parts by mass |
| Propylene glycol monomethyl ether | 30 parts by mass |
| BYK-381 (surface active agent: | 1 part by mass |
| manufactured by BYK Japan KK) | |

Furthermore, AUP-787 is a resin composition containing urethane acrylate, a photopolymerization initiator, and methyl ethyl ketone.

<Production of Light Reflecting Films 102 to 107>

The light reflecting films 102 to 107 were prepared in the same manner as above except that the drying temperature and time for the buffer layer are modified to have the content of uncured monomer described in Table 1.

<Production of Light Reflecting Film 108>

The light reflecting film 108 was prepared in the same manner as above except that, regarding the production of light reflecting film 104, an aging treatment at 35° C. is carried out for 3 days after coating and thermal curing of the buffer layer and the self-restoring layer is formed thereafter.

<Production of Light Reflecting Film 109: Comparative Example>

The comparative light reflecting film 109 was prepared in the same manner as above except that, regarding the light reflecting film 103, the buffer layer is not formed and the following hard coat layer composition is used for forming the self-restoring layer.

[Hard Coat Layer Composition]

| | |
|---|---|
| Dipentaerythritol penta and hexaacrylate | 100 parts by mass |
| (NKesterA-9550, manufactured by Shin Nakamura | |
| Chemical Co., Ltd.) | |
| IRGACURE184 (manufactured by BASF Japan) | 5 parts by mass |
| BYK-381 | 1 part by mass |
| propylene glycol monomethyl ether | 10 parts by mass |
| methylacetate | 45 parts by mass |
| methyl ethyl ketone | 45 parts by mass |

### <Production of Light Reflecting Films 110 to 115>

The light reflecting films 110 to 115 were prepared in the same manner as above except that, regarding the production of light reflecting films 101 to 108, the IR reflecting film 2 is used as a light reflecting body instead of the IR reflecting film 1.

<Production of Light Reflecting Film 116: Comparative Example>

The light reflecting film 116 of Comparative Example was prepared in the same manner as above except that, regarding the production of light reflecting film 109, the IR reflecting film 2 is used as a light reflecting body.

<<Evaluation of Light Reflecting Film>>

### (1) Measurement of Visible Light Transmittance and Reflectance in Near IR to IR Region

The transmittance in light wavelength range of 450 to 650 nm and reflectance in light wavelength range of 1000 to 1500 nm of the IR reflecting films 1 and 2 were measured by using a spectrophotometer (using integrating sphere, Model U-4000, manufactured by Hitachi High Technologies Corporation) in an environment of 23° C., 55% RH. The average transmittance and average reflectance were obtained, and the results are shown in Table 1.

TABLE 1

| | Average | Average | Average |
|---|---|---|---|
| | transmittance | reflectance | reflectance |
| | in light | in light | in light |
| Light | wavelength | wavelength | wavelength |
| reflecting | range of | range of | range of |
| body | 450 to 650 nm | 1000 to 1500 nm | 450 to 650 nm |
| No. | (%) | (%) | (%) |
| 1 | 90 | 89 | — |
| 2 | 85 | 84 | — |
| 3 | — | — | 91 |
| 4 | — | — | 88 |

(2) Measurement of Micro Hardness Parameters h₁ and h₂ and Restoring Degree (A) of Self-Restoring Layer

With regard to each light reflecting film produced above, by using a micro hardness tester which uses a Vickers indenter and a pyramid indenter with a ridge line angle of 115 degrees, a surface of the light reflecting film was pressed with an indenter with set indentation depth hₘₐₓ (μm) and the load test force-indentation depth curve is established. In addition, from the indentation depth (h₁, h₂) which is obtained by the measurement with unloading hold time of 0 seconds or 60 seconds, A=(h₁−h₂)/hₘₐₓ) is calculated (see, FIG. 1). This measurement is performed for 5 different spots of the sample, and the average value is calculated and used as restoring degree (A). The obtained results are shown in Table 2.

As specific conditions for measurement, the measurement can be made at the following conditions by using Dynamic Ultra-Micro Hardness Tester DUH-211S (manufactured by SHIMADZU CORPORATION).

Indenter shape: Pyramid indenter (ridge line angle of 115°)

Measurement environment: Temperature of 23° C. and relative humidity of 50%
Maximum test load: 196.13 mN
Loading speed: 6.662 mN/10 seconds
Unloading speed: 6.662 mN/10 seconds

(3) Quantification of Uncured Monomer in Buffer Layer

Content of uncured monomer in the buffer layer either before or after the decorative molding was measured by the following method, and the obtained results are shown in Table 2.

(Quantification Method and Data Processing)

ATR (Attenuated Total Reflection) of the buffer layer obtained by cutting a sample of light reflecting film was measured by using FT/IR-4100 (manufactured by JASCO Corporation) in a wave number range of 400⁻¹ to 6000 cm⁻¹. Reflected light intensity was obtained for each of the following wave numbers.

R1: Reflected light intensity at 2270 cm⁻¹.

R2: Reflected light intensity at 2950 cm⁻¹.

By calculating R1/R2, the uncured component was quantified.

Herein,

A: R1/R2 after coating the buffer layer; uncured monomer 100%
B: R1/R2 after curing treatment for 30 minutes at 150° C. following coating of the buffer layer; 0% of uncured monomer, and from the above data, the ratio of uncured monomer, i.e., MM, was obtained based on the following formula.

(Ratio MM of uncured monomer (% by mass))=(R1/R2−B)/(A−B)×100

(4) Scratch Resistance

After elongating and attaching each light reflecting film produced above to have a curved surface shape as a model, the scratch resistance was measured according to the following method.

Elongation molding of light reflecting film 101: To a curved surface of glass with φ100 mm, the light reflecting film was attached at decorative molding temperature of 150° C. Similarly, each of the light reflecting films 102 to 108 and 110 to 115 was subjected to decorative molding with modification of the decorative molding temperature to 150° C., 120° C., 80° C. and 70° C. and combination shown in Table 2.

Scratch resistance test: By using a reciprocating abrasion tester (HEIDON-14DR, manufactured by Shinto Scientific Co., Ltd.) and applying steel wool (#0000) as abrasives, surface of each film mirror was subjected to 10 times of reciprocating abrasion at rate of 10 mm/sec with a load condition of 500 g/cm². Scratches after the test were evaluated according to the following criteria.

[symbol] : No scratches are formed at all.

◯: Slight scratches are formed but they are not evident.

Δ: Scratches can be observed by an eye, but they are within a practically acceptable range.

x: Scratches are clearly observed by an eye, and irregularities of the scratches are formed on surface, and thus not acceptable.

(5) Light Resistance

Each light reflecting film produced above was cut to have 10 cm square, and as an evaluation of light resistance, the following acceleration test was performed for each sample. Accordingly, a change in IR reflectance was measured according to the following method.

To mimic an outdoor environment, in an environment with 65° C., UV irradiation was performed for 96 hours at 150 mW by using Eye Super UV tester manufactured by Iwasaki Electric Co., Ltd. Accordingly, the specular reflectance was measured. A change in IR reflectance before and after the acceleration test was evaluated according to the following criteria.

<Measurement of IR Reflectance>

As a spectrophotometer, by using a Model U-4000 (manufactured by Hitachi High Technologies Corporation), reflectance of the each light reflecting film in light wavelength range of 1000 to 1500 nm was measured in an environment of 23° C., 55% RH. Specifically, the specular reflectance at incident angle of 5° of incident light relative to the normal line of the reflecting surface was measured at 10 points having same interval in the width direction of the film. By obtaining the average value, it was used as the IR reflectance (%).

[symbol] : Decrease in reflectance is 0% or more but less than 1%

◯: Decrease in reflectance is 1% or more but less than 3%

Δ: Decrease in reflectance is 3% or more but less than 5%

x: Decrease in reflectance is 5% or more

Constitution of the light reflecting film and the above evaluation results are shown in the following Table 2.

TABLE 2

| | | Buffer layer | | | | | | | | | | |
|---|---|---|---|---|---|---|---|---|---|---|---|---|
| | | | | | Ratio of | | | | | | | |
| | | | | | uncured | After decorative | | | | | | |
| | | | | | monomer | molding | | Self-restoring | | | | |
| | | | Conditions for | | before | | Ratio of | layer | | | | |
| | | Layer | heat curing | | decorative | Molding | uncured | Layer | | Evaluation | | |
| Light | Light | thick- | Temper- | | molding | temper- | monomer | thick- | Restoring | Scratch | Light | |
| reflecting | reflecting | ness | ature | Time | (% by | ature | (% by | ness | degree | resis- | resis- | |
| film No. | body No. | (μm) | (° C.) | (min) | mass) | (° C.) | mass) | (μm) | (A) | tance | tance | Remarks |
| 101 | 1 | 5 | 80 | 0.25 | 83.0 | 150 | 0.08 | 20 | 0.50 | ◯ | ◯ | Present |
| | | | | | | | | | | | | invention |
| 102 | 1 | 5 | 80 | 0.5 | 80.0 | 150 | 0.05 | 20 | 0.50 | ⊙ | ◯ | Present |
| | | | | | | | | | | | | invention |
| 103 | 1 | 5 | 80 | 1 | 50.0 | 120 | 0.10 | 20 | 0.30 | ⊙ | ⊙ | Present |
| | | | | | | | | | | | | invention |
| 104 | 1 | 5 | 80 | 3 | 5.0 | 80 | 3.00 | 20 | 0.04 | ⊙ | ⊙ | Present |
| | | | | | | | | | | | | invention |
| 105 | 1 | 5 | 80 | 4 | 4.5 | 80 | 3.00 | 20 | 0.04 | ◯ | ◯ | Present |
| | | | | | | | | | | | | invention |
| 106 | 1 | 5 | 80 | 3 | 5.0 | 70 | 3.50 | 20 | 0.02 | ◯ | ◯ | Present |
| | | | | | | | | | | | | invention |
| 107 | 1 | 5 | 80 | 4 | 4.5 | 70 | 3.50 | 20 | 0.02 | ◯ | ◯ | Present |
| | | | | | | | | | | | | invention |
| 108 | 1 | 5 | 80/35* | 3/3 | 3.0 | 80 | 1.50 | 20 | 0.04 | ◯ | ⊙ | Present |
| | | | | day^{} | | | | | | | | invention |
| 109 | 1 | — | — | — | — | — | — | 20 | 0.01 | X | X | Comparative |
| | | | | | | | | | | | | Example |
| 110 | 2 | 5 | 80 | 0.5 | 80.0 | 150 | 0.05 | 20 | 0.50 | ◯ | ◯ | Present |
| | | | | | | | | | | | | invention |
| 111 | 2 | 5 | 80 | 1 | 50.0 | 120 | 0.10 | 20 | 0.30 | ◯ | ◯ | Present |
| | | | | | | | | | | | | invention |
| 112 | 2 | 5 | 80 | 3 | 5.0 | 80 | 3.00 | 20 | 0.04 | ◯ | ◯ | Present |
| | | | | | | | | | | | | invention |
| 113 | 2 | 5 | 80 | 4 | 4.5 | 80 | 3.00 | 20 | 0.04 | Δ | Δ | Present |
| | | | | | | | | | | | | invention |
| 114 | 2 | 5 | 80 | 3 | 5.0 | 70 | 3.50 | 20 | 0.02 | ◯ | ◯ | Present |
| | | | | | | | | | | | | invention |
| 115 | 2 | 5 | 80 | 4 | 4.5 | 70 | 3.50 | 20 | 0.02 | Δ | Δ | Present |
| | | | | | | | | | | | | invention |
| 116 | 2 | — | — | — | — | — | — | 20 | 0.01 | X | X | Comparative |
| | | | | | | | | | | | | Example |

^{}Aging conditions

From Table 2, it was found that, compared to Comparative Examples 109 and 116, the light reflecting films 101 to 108 and 110 to 115 of the present invention having a buffer layer and a self-restoring layer formed therein have better scratch resistance after elongation molding to have a curve surface shape. It was also found that, according to the layer constitution in which a polymer blended with UV stable monomer and UV absorbing monomer is used and thermally cured for the buffer layer, the light reflecting film of the present invention also has excellent light resistance.

According to comparison of the light reflecting bodies (IR reflecting films) 1 and 2, constitution of the light reflecting body 1 was found to be excellent in terms of scratch resistance and light resistance.

Furthermore, the light reflecting film 108 which is obtained by performing an aging treatment after forming a buffer layer followed by forming of the self-restoring layer is found to have slightly lower scratch resistance than the light reflecting film 104 which has a self-restoring layer continuously formed therein.

### Example 2

### <<Light Reflecting Body: Production of Film Mirror and Metal Gloss Film>>

### [Light Reflecting Body 3: Production of Film Mirror]

As a transparent substrate film, a biaxially stretched polyester film (polyethylene terephthalate film, thickness of 25 μm) was used. On a single surface of the polyethylene terephthalate film, a resin in which a polyester resin (poly ester(ester) SP-181 manufactured by The Nippon Synthetic Chemical Industry Co., Ltd.), a melamine resin (SUPER BECKAMINE J-820 manufactured by DIC Corporation), TDI based isocyanate (2,4-tolylene diisocyanate), and HDMI (registered trademark) based isocyanate (1,6-hexamethylene diisocyanate) are mixed in toluene in resin solid content ratio of 20:1:1:2 to have solid matter concentration of 10% by mass was applied by gravure coating method to form an anchor layer with thickness of 0.1 μm. On top of the anchor layer, a silver reflecting layer with thickness of 100 nm was formed as a silver reflecting layer by vacuum vapor deposition method. On top of the silver reflecting layer, a resin in which a polyester based resin and TDI (tolylene diisocyanate) based isocyanate are mixed in resin solid content ratio of 10:2 was applied by gravure coating method to form a resin coating layer 8 with thickness of 3.0 μm. Accordingly, a film mirror was produced as a light reflecting body (see, FIG. 5B).

[Light Reflecting Body 4: Production of Metal Gloss Film]

A metal gloss film was produced according to the following steps in view of the examples of JP 2014-108570 A.

As the polyester A, polyethylene terephthalate having intrinsic viscosity of 0.8 was used. Furthermore, in the polyester B, 30% by mol of cyclohexane dimethanol was used as an acid component and polyethylene terephthalate copolymerized with 30% by mol of spiroglycol was used as a diol component. The polyester A and the polyester B were supplied to an extruder after being dried separately.

Each of the polyester A and the polyester B was prepared in melt state at 280° C. in an extruder, and while measuring them to have discharge ratio of the polyester A composition/the polyester B composition=1.66/1 using gear pump, they were passed through a filter and combined in a feed block. Combined polyester A and polyester B were supplied to a static mixer, and combined in 549-layer feed block having a constitution in which one slit plate with slit number of 275 and one slit plate with slit number of 274 in thickness direction are alternately used, in which the polyester A includes 275 layers and the polyester B includes 274 layers to have a laminate in which 549 layers are alternately laminated in thickness direction. Meanwhile, in each slit plate used, all the width of a slit formed on the thick film layer present at both ends was prepared to be constant while only the length was changed. Furthermore, the ratio of change in slit length was set at 0.59. Furthermore, with regard to the specifications of the laminate structure, a laminate was prepared to have a slanted structure in which 275 layers of the polyester A and 274 layers of the polyester B are alternately laminated in thickness structure.

The obtained laminate including 549 layers in total was supplied to a T die for molding into a sheet shape. After molding, under electrostatic application, it was rapidly cooled and solidified on a casting drum of which surface temperature is maintained at 25° C.

The obtained case film was heated by a roll group which is set at 85° C. to 100° C., and after stretching by 3.2 times in longitudinal direction, the resulting monoaxially stretched film was coated with an aqueous coating agent (X) which has been mixed to have the following composition.

(Composition of Aqueous Coating Agent (X))

Aqueous dispersion of acryl urethane copolymerization resin (a): “Sannaron” WG-658 manufactured by Sannan Chemical Industry Co., Ltd. (solid content concentration of 30% by mass)
Aqueous dispersion of isocyanate compound (b): “ELASTRON” E-37 manufactured by Dai-ichi Kogyo Seiyaku Co., Ltd. (solid content concentration of 28% by mass)
Epoxy compound (c): “CR-5L” manufactured by DIC Corporation (solid content concentration of 100% by mass)
Aqueous dispersion of composition including compound (d−1) with polythiophene structure and compound (d−2) with anion structure:

To 1887 parts by mass of an aqueous solution containing 20.8 parts by mass of polystyrene sulfonic acid as a compound having anionic structure, 49 parts by mass of 1% by mass aqueous solution of iron (III) sulfate, 8.8 parts by mass of 3,4-ethylenedioxythiophene as a compound having a thiophene structure, and 117 parts by mass of 10.9% by mass aqueous solution of peroxodisulfuric acid were added. The mixture was stirred for 23 hours at 18° C. Subsequently, the mixture was added with 154 parts by mass of cationic exchange resin and 232 parts by mass of anionic exchange resin. After stirring for 2 hours, the ion exchange resins were separated by filtration to obtain an aqueous dispersion of composition (d−1)+(d−2) which includes poly(3,4-ethylenedioxythiophene) and polystyrene sulfonic acid. Furthermore, the mass ratio between the compound having a polythiophene structure and the compound having an anionic structure (i.e., compound having polythiophene structure/compound having anionic structure) is 4/6. Furthermore, the solid content concentration in the aqueous dispersion of composition (d−1)+(d−2) which includes the obtained compound having polythiophene structure and compound having anionic structure is 1.3% by mass.

Aqueous Solvent (G): Pure Water

The above aqueous dispersions of (a) to (d−2) were mixed with the aqueous coating agent (X) for adjusting concentrations to have solid content mass ratio of (a)/(b)/(c)/(d−1)+(d−2)=100/100/75/25 and 3% by mass of solid content concentration of the aqueous coating agent (X).

The monoaxially stretched film coated with aqueous coating agent (X) was led to a tenter, and after preheating with hot air at 100° C., it was stretched by 3.3 times in the width direction at a temperature of 110° C. The stretched film was heat-treated at relax ratio of 3% and hot wind at 150° C. in the tenter. After cooling to room temperature, the film was wound. As a result, a first film having thickness of 52 μm was obtained.

A second film having thickness of 71 μm was obtained in the same manner as above except the thickness of polyester film.

To the obtained first film, the following adhesive was applied to have 7 g/m² in wet thickness, and after drying at rate of 20 m/min with drying temperature of from 70° C. to 90° C., attaching to the second film was performed using a nip roll at nip pressure of 0.4 MPa and temperature of 40° C.

(Adhesives)

5 parts by mass of urethane prepolymer solution “Takelac A-971” manufactured by Mitsui Chemical & Polyurethanes Inc. and 0.5 parts by mass of “Takeneto A-3” were dissolved in 5 parts by mass of ethyl acetate and used.

During the conveying step after attachment, on 17 conveying rolls having a diameter of 100 mm which have contact angle of 60 to 180° between the conveying roll and sheet, both ends were clamped and earthed using 0.2 mmφ tungsten at a position at which distance L is 80 mm and distance D is 20 mm

The sheet was wound after attaching. To a wound sheet part, however, an ionizer of alternating voltage application type (i.e., corona electric discharge type) for generating ion current (ionizer monitor SW001 of ion current measurement device) of ±0.3 μA or more was installed.

<<Production of Light Reflecting Film>>

### <Production of Light Reflecting Films 201 to 208>

On top of the light reflecting layer (resin coating layer) of the light reflecting body 3 which has been produced above, the buffer layer and self-restoring layer described in Table 3 were formed in the same manner as the light reflecting films 102 to 109 of Example 1 to produce each of the light reflecting films 201 to 208.

<Production of Light Reflecting Films 209 to 215>

On top of the light reflecting layer of the light reflecting body 4 which has been produced above, the buffer layer and self-restoring layer described in Table 3 were formed in the same manner as the light reflecting films 110 to 116 of Example 1 to produce each of the light reflecting films 209 to 215.

<<Evaluation of Light Reflecting Film>>

Visible light reflectance (described in Table 1), micro hardness parameters h₁, h₂ and restoring degree (A) of self-restoring layer, ratio of uncured monomer before and after decorative molding, scratch resistance, and light resistance were evaluated in the same manner as Example 1.

Meanwhile, with regard to the light resistance, for a sample before and after the acceleration test using Eye Super UV tester manufactured by Iwasaki Electric Co., Ltd., the average reflectance of each light reflecting film in light wavelength range of 450 to 650 nm was measured in an environment of 23° C., 55% RH by using a Model U-4000 spectrophotometer (manufactured by Hitachi High Technologies Corporation), specifically, at 10 points having same interval in the width direction of the film. By obtaining the average value, it was used as the visible light reflectance (%). A change in the visible light reflectance was evaluated according to the above criteria.

Constitution of the light reflecting film and the above evaluation results are shown in the following Table 3.

TABLE 3

| | | Buffer layer | | | | | | | | | | |
|---|---|---|---|---|---|---|---|---|---|---|---|---|
| | | | | | Ratio of | | | | | | | |
| | | | | | uncured | After decorative | | | | | | |
| | | | | | monomer | molding | | | | | | |
| | | | Conditions for | | before | | Ratio of | Self-restoring layer | | | | |
| | | Layer | heat curing | | decorative | Molding | uncured | Layer | | Evaluation | | |
| Light | Light | thick- | Temper- | | molding | temper- | monomer | thick- | Restoring | Scratch | Light | |
| reflecting | reflecting | ness | ature | Time | (% by | ature | (% by | ness | degree | resis- | resis- | |
| film No. | body No. | (μm) | (° C.) | (min) | mass) | (° C.) | mass) | (μm) | (A) | tance | tance | Remarks |
| 201 | 3 | 5 | 80 | 0.5 | 80.0 | 150 | 0.05 | 20 | 0.50 | ⊙ | ◯ | Present |
| | | | | | | | | | | | | invention |
| 202 | 3 | 5 | 80 | 1 | 50.0 | 120 | 0.10 | 20 | 0.30 | ⊙ | ⊙ | Present |
| | | | | | | | | | | | | invention |
| 203 | 3 | 5 | 80 | 3 | 5.0 | 80 | 3.00 | 20 | 0.04 | ⊙ | ⊙ | Present |
| | | | | | | | | | | | | invention |
| 204 | 3 | 5 | 80 | 4 | 4.5 | 80 | 3.00 | 20 | 0.04 | ◯ | ◯ | Present |
| | | | | | | | | | | | | invention |
| 205 | 3 | 5 | 80 | 3 | 5.0 | 70 | 3.50 | 20 | 0.02 | ◯ | ◯ | Present |
| | | | | | | | | | | | | invention |
| 206 | 3 | 5 | 80 | 4 | 4.5 | 70 | 3.50 | 20 | 0.02 | ◯ | ◯ | Present |
| | | | | | | | | | | | | invention |
| 207 | 3 | 5 | 80/35* | 3/3 | 3.0 | 80 | 1.50 | 20 | 0.04 | ◯ | ⊙ | Present |
| | | | | day^{} | | | | | | | | invention |
| 208 | 3 | — | — | — | — | — | — | 20 | 0.01 | X | X | Comparative |
| | | | | | | | | | | | | Example |
| 209 | 4 | 5 | 80 | 0.5 | 80.0 | 150 | 0.05 | 20 | 0.50 | ◯ | ◯ | Present |
| | | | | | | | | | | | | invention |
| 210 | 4 | 5 | 80 | 1 | 50.0 | 120 | 0.10 | 20 | 0.30 | ◯ | ◯ | Present |
| | | | | | | | | | | | | invention |
| 211 | 4 | 5 | 80 | 3 | 5.0 | 80 | 3.00 | 20 | 0.04 | ◯ | ◯ | Present |
| | | | | | | | | | | | | invention |
| 212 | 4 | 5 | 80 | 4 | 4.5 | 80 | 3.00 | 20 | 0.04 | Δ | Δ | Present |
| | | | | | | | | | | | | invention |
| 213 | 4 | 5 | 80 | 3 | 5.0 | 70 | 3.50 | 20 | 0.02 | ◯ | ◯ | Present |
| | | | | | | | | | | | | invention |
| 214 | 4 | 5 | 80 | 4 | 4.5 | 70 | 3.50 | 20 | 0.02 | Δ | Δ | Present |
| | | | | | | | | | | | | invention |
| 215 | 4 | — | — | — | — | — | — | 20 | 0.01 | X | X | Comparative |
| | | | | | | | | | | | | Example |

^{}Aging conditions

The light reflecting films 201 to 207 and 209 to 214 of the present invention in which Example 1 is reproduced and a buffer layer is formed were found to have better scratch resistance after elongation molding to a curve surface shape compared to Comparative Examples 208 and 215. It was also found that, due to the layer constitution in which a UV stable monomer and a UV absorbing monomer are blended and thermally cured in the buffer layer, excellent light resistance is obtained.

Based on the comparison of the light reflecting bodies 3 and 4, it was found that both the scratch resistance and light resistance are excellent in the constitution of the light reflecting body 3.

It was also shown that the light reflecting film 207 in which an aging treatment is carried out after forming a buffer layer followed by forming of a self-restoring layer has slightly weaker scratch resistance compared to the light reflecting film 203 in which a self-restoring layer has been continuously formed.

### Example 3

### <<Production of Laminated Glass>>

By using the light reflecting films 101 to 109 produced above, the laminated glasses 301 to 309 were produced.

On a side of the light reflecting film 101 to 109 on which a self-restoring layer has not been applied, a polyvinyl butyral film each with thickness of 380 μm was provided as a polyvinyl acetal based resin film.

[Production of Laminated Glass]

As an indoor side glass, 3 mm thick green glass with flat shape (visible light transmittance Tv: 81%, sun light transmittance Te: 63%) and the light reflecting film 1 to 108 which have been produced above, and as an outdoor side glass, 3 mm thick clear glass with flat shape (visible light transmittance Tv: 91%, sun light transmittance Te: 86%) were laminated in the order. After removing the extra part protruding from the edge part of the glass, it was heated for 30 minutes at 150° C. followed by a customizing treatment based on deaeration under pressure to produce laminated glass 301. Laminated glasses 302 to 309 were produced in the same manner as above with the treatment of them at the temperature described in Table 4.

<<Evaluation of Laminated Glass>>

With regard to the following scratch resistance of laminated glass, evaluation of heat wrinkles was performed.

(1) Scratch Resistance

With regard to the processing of laminated glass, easiness of having scratches on a surface of the light reflecting film during the processing was determined based on naked eye observation of 10 pieces of laminated glass, each has been separately produced. Evaluation was made based on the following criteria.

[symbol] : No scratch

◯: Some scratches, but they are at a level at which confirmation can be made with a Lupe.

Δ: Scratches are at a level at which they can be confirmed.

x: Many scratches, and they are at a level at which overall cloudiness is shown.

(2) Heat Wrinkle

Laminated glass with heat wrinkles was observed with a naked eye and the occurrence of heat wrinkles during the processing was evaluated based on the following evaluation criteria.

[symbol] : There are no heat wrinkles

◯: Some wrinkles, but they are at a level at which confirmation can be made with a Lupe.

Δ: Wrinkles are at a level at which they can be confirmed by a naked eye.

x: Wrinkles are at a level at which the vision is impaired by them.

The above evaluation results are shown in Table 4.

TABLE 4

| | | | Buffer layer | | | | | | | | | | |
|---|---|---|---|---|---|---|---|---|---|---|---|---|---|
| | | | | | | Ratio of | | | | | | | |
| | | | | | | uncured | After decorative | | | | | | |
| | | | | | | monomer | molding | | | | | | |
| | Light | Light | | Conditions for | | before | | Ratio of | Self-restoring layer | | | | |
| Lami- | reflect- | reflect- | Layer | heat curing | | decorative | Molding | uncured | Layer | | Evaluation | | |
| nated | ing | ing | thick- | Temper- | | molding | temper- | monomer | thick- | Restoring | Scratch | Heat | |
| glass | film | body | ness | ature | Time | (% by | ature | (% by | ness | degree | resis- | wrin- | |
| No. | No. | No. | (μm) | (° C.) | (min) | mass) | (° C.) | mass) | (μm) | (A) | tance | kles | Remarks |
| 301 | 101 | 1 | 5 | 80 | 0.25 | 83.0 | 150 | 0.08 | 20 | 0.50 | ◯ | ◯ | Present |
| | | | | | | | | | | | | | invention |
| 302 | 102 | 1 | 5 | 80 | 0.5 | 80.0 | 150 | 0.05 | 20 | 0.50 | ⊙ | ⊙ | Present |
| | | | | | | | | | | | | | invention |
| 303 | 103 | 1 | 5 | 80 | 1 | 50.0 | 120 | 0.10 | 20 | 0.30 | ⊙ | ⊙ | Present |
| | | | | | | | | | | | | | invention |
| 304 | 104 | 1 | 5 | 80 | 3 | 5.0 | 80 | 3.00 | 20 | 0.04 | ⊙ | ⊙ | Present |
| | | | | | | | | | | | | | invention |
| 305 | 105 | 1 | 5 | 80 | 4 | 4.5 | 80 | 3.00 | 20 | 0.04 | ◯ | ◯ | Present |
| | | | | | | | | | | | | | invention |
| 306 | 106 | 1 | 5 | 80 | 3 | 5.0 | 70 | 3.50 | 20 | 0.02 | ◯ | ◯ | Present |
| | | | | | | | | | | | | | invention |
| 307 | 107 | 1 | 5 | 80 | 4 | 4.5 | 70 | 3.50 | 20 | 0.02 | ◯ | ◯ | Present |
| | | | | | | | | | | | | | invention |
| 308 | 108 | 1 | 5 | 80/35* | 3/3 | 3.0 | 80 | 1.50 | 20 | 0.04 | ◯ | ⊙ | Present |
| | | | | | day^{} | | | | | | | | invention |
| 309 | 109 | 1 | — | — | — | — | — | — | 20 | 0.01 | X | X | Comparative |
| | | | | | | | | | | | | | Example |

^{}Aging conditions

It was found that the laminated glass in which the light reflecting films 101 to 108 of the present invention are used has better scratch resistance during processing compared to the laminated glass in which the comparative light reflecting film 109 is used. It was also found that, by having the buffer layer and self-restoring layer of the present invention, the elasticity is enhanced and excellent resistance against an occurrence of heat wrinkles during the processing can be exhibited.

### INDUSTRIAL APPLICABILITY

Since the light reflecting film of the present invention can improve the self-restoring property of a stretched section thereof when stretched and attached to a curved surface and has excellent scratch resistance and light resistance, it can be suitably used as an IR reflecting film, a film mirror and a metal gloss film as a light reflecting body, a light reflecting film provided in laminated glass, and a film for decoration of a surface of plastic body that is used for home appliances, OA instruments, cellular phones, or interior decoration of automobiles.

### REFERENCE SIGNS LIST

RF Light reflecting film
1 Light reflecting body
2 Substrate film
3 Light reflecting layer
4 Buffer layer
5 Self-restoring layer
L Light source
WF IR reflecting film
MF Film mirror
6 Anchor layer
7 Metal layer
8 Resin coating layer
9 Adhesive layer
10 Acrylic resin layer
11 Sticky layer
12 Releasing sheet

1. A light reflecting film comprising a self-restoring layer which is formed on a light reflecting body provided with at least a substrate film and a light reflecting layer, wherein a restoring degree (A) of the self-restoring layer as defined by the following formula is 0.02 or more, and a buffer layer is provided between the light reflecting body and the self-restoring layer:
A=(h₁−h₂)/hₘₐₓ
h₁: residual depth (μm) measured at an unloading hold time of 0 seconds
h₂: residual depth (μm) measured at an unloading hold time of 60 seconds,
hₘₐₓ: set indentation depth (m).

2. The light reflecting film according to claim 1, wherein the buffer layer contains a polymer which is polymerized with a monomer composition containing at least one selected from UV stable monomers and at least one selected from UV absorbing monomers and a ratio of uncured monomer in the buffer layer before decorative molding is 5% by mass or more.

3. The light reflecting film according to claim 2, wherein the ratio of uncured monomer in the buffer layer after decorative molding is 3% by mass or less.

4. The light reflecting film according to claim 1, wherein light reflectance of the light reflecting film in a light wavelength range of 1000 to 1500 nm is 50% or more.

5. The light reflecting film according to claim 1, wherein light reflectance of the light reflecting film in a light wavelength range of 450 to 650 nm is 50% or more.

6. A method for producing the light reflecting film according to claim 1, comprising:
applying a buffer layer coating solution for forming the buffer layer on the light reflecting body followed by thermal curing; and
then forming a self-restoring layer on the buffer layer without performing an aging treatment.

7. A method for decorative molding of the light reflecting film according to claim 1, comprising:
forming a sticky layer or an adhesive layer on a surface of the light reflecting film opposite to the self-restoring layer; and
attaching the light reflecting film to a substrate via the sticky layer or adhesive layer while performing thermal molding at temperature of 80° C. or higher.

8. Laminated glass obtained by sandwiching the light reflecting film according to claim 4 between two members for constituting laminated glass.

9. A curved surface body comprising the light reflecting film according to claim 5.

10. The light reflecting film according to claim 2, wherein light reflectance of the light reflecting film in a light wavelength range of 1000 to 1500 nm is 50% or more.

11. The light reflecting film according to claim 2, wherein light reflectance of the light reflecting film in a light wavelength range of 450 to 650 nm is 50% or more.

12. A method for producing the light reflecting film according to claim 2, comprising:
applying a buffer layer coating solution for forming the buffer layer on the light reflecting body followed by thermal curing; and
then forming a self-restoring layer on the buffer layer without performing an aging treatment.

13. A method for decorative molding of the light reflecting film according to claim 2, comprising:
forming a sticky layer or an adhesive layer on a surface of the light reflecting film opposite to the self-restoring layer; and
attaching the light reflecting film to a substrate via the sticky layer or adhesive layer while performing thermal molding at temperature of 80° C. or higher.

14. The light reflecting film according to claim 3, wherein light reflectance of the light reflecting film in a light wavelength range of 1000 to 1500 nm is 50% or more.

15. The light reflecting film according to claim 3, wherein light reflectance of the light reflecting film in a light wavelength range of 450 to 650 nm is 50% or more.

16. A method for producing the light reflecting film according to claim 3, comprising:
applying a buffer layer coating solution for forming the buffer layer on the light reflecting body followed by thermal curing; and
then forming a self-restoring layer on the buffer layer without performing an aging treatment.

17. A method for decorative molding of the light reflecting film according to claim 3, comprising:
forming a sticky layer or an adhesive layer on a surface of the light reflecting film opposite to the self-restoring layer; and
attaching the light reflecting film to a substrate via the sticky layer or adhesive layer while performing thermal molding at temperature of 80° C. or higher.

18. A method for producing the light reflecting film according to claim 4, comprising:
applying a buffer layer coating solution for forming the buffer layer on the light reflecting body followed by thermal curing; and
then forming a self-restoring layer on the buffer layer without performing an aging treatment.

19. A method for decorative molding of the light reflecting film according to claim 4, comprising:
forming a sticky layer or an adhesive layer on a surface of the light reflecting film opposite to the self-restoring layer; and
attaching the light reflecting film to a substrate via the sticky layer or adhesive layer while performing thermal molding at temperature of 80° C. or higher.

20. A method for producing the light reflecting film according to claim 5, comprising:
applying a buffer layer coating solution for forming the buffer layer on the light reflecting body followed by thermal curing; and
then forming a self-restoring layer on the buffer layer without performing an aging treatment.
